(19) United States
(12) Patent Application Publication
(10) Pub. No.: US 2013/0084146 A1
(43) Pub. Date: Apr. 4, 2013

(54) BATCHER UNIT IN A BOOK BLOCK FINISHING MACHINE AND METHOD OF OPERATING SAME

(71) Applicants: Michael Speller, Aurora (CA); Ross Hoge, Kirkland (CA)

(72) Inventors: Michael Speller, Aurora (CA); Ross Hoge, Kirkland (CA)

(21) Appl. No.: 13/633,997

(22) Filed: Oct. 3, 2012

Related U.S. Application Data
(60) Provisional application No. 61/542,588, filed on Oct. 3, 2011.

(51) Int. Cl. B42C 9/00

(52) U.S. Cl. CPC B42C 9/0006
USPC 412/37

(57) ABSTRACT

A batcher unit for a book block finishing machine can include at least one receiving member to receive a plurality of sheets and stack the plurality of sheets into a book block having a binding face lying in a binding plane. The batcher unit can also include at least one adhesive applicator to apply adhesive to the at least one binding face of the book block to bind together the edges of plurality of sheets. The adhesive applicator can be moveable in relative to the binding plane and can direct a stream of adhesive toward the binding plane along a first adhesive axis when the adhesive applicator is in a first position, and along a second adhesive axis when the adhesive applicator is in a second position. The first and second adhesive axes can intersect the binding plane at respective angles.

### RELATED APPLICATIONS

This application claims the benefit of 35 USC 119 based on the priority of co-pending U.S. Provisional Patent Application 61/542,588, filed Oct. 3, 2011, such application being incorporated herein in its entirety by reference.

### FIELD

The described embodiments relate to a batcher unit for use in a book block finishing machine, and a method for using the same.

### INTRODUCTION

Digital printing presses are an alternative to traditional offset printing presses and can be used to create multiple copies of a printed work. In some examples of digital printing presses, the printed content is applied to a continuous length of web, and the web is then cut and sorted to form a book. One method of converting the printed continuous web into a book involves the individual pages of the printed content (i.e., the book being printed) being cut, separated and stacked into book blocks. A portion of the digital printing press known as the finishing machine or book block finishing machine can perform at least some of these operations.

Conventional finishing machines can take a considerable amount of time to allow for a format change (i.e., to accept a different book block size and shape), which may require the associated digital printing press to also stop for a period of time. This can reduce some of the “change-on-the-fly” advantage of digital printing presses.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

According to one broad aspect of the invention, a batcher unit for a book block finishing first adhesive axis machine can include at least one receiving member to receive a plurality of sheets and stack the plurality of sheets into a book block having a binding face lying in a binding plane. The batcher unit can also include at least one adhesive applicator to apply adhesive to the at least one binding face of the book block to bind together the edges of plurality of sheets in the book block lying in the binding plane. The at least one adhesive applicator can be moveable in relative to the binding plane between a first position and a second position. The at least one adhesive applicator can include a nozzle apparatus configured to direct at least one stream of adhesive toward the binding plane along a first adhesive axis when the adhesive applicator is in the first position, and to direct the at least one stream of adhesive toward the binding plane along a second adhesive axis when the adhesive applicator is in the second position. The first adhesive axis can intersect the binding plane at a first angle and the second adhesive axis intersecting the binding plane at a different second angle.

The batcher unit can also include a shuttle apparatus associated with the receiving member to remove the book block from the at least one receiving member. The shuttle apparatus can be operable to translate the book block between an upstream position and a downstream position in a second direction while the adhesive applicator moves between the first and second positions in the first direction. The second direction can be different than the first direction.

The shuttle apparatus can include a clamp mechanism to clamp the stacks of sheets while the adhesive is being applied. The clamp mechanism can include a first clamp member having a first clamp surface to contact a cover sheet of the book block, and an opposed second clamp member having a second clamp surface to contact an opposed base sheet of the book block. The clamp mechanism can be translatable with the shuttle in the second direction.

The at least one adhesive applicator can oscillate between the first and second positions in the first direction as the clamp mechanism translates the book block in the second direction.

The batcher unit can also include a controller communicably linked to each adhesive applicator and the clamp mechanism. The controller can be operable to automatically control the relative movement of the adhesive applicator and the clamp mechanism.

When the adhesive applicator is in the first position the first adhesive axis can intersect the binding plane at substantially the same elevation as a base plane containing the base sheet in the book block.

When the adhesive applicator is in the second position the second adhesive axis can intersect the binding plane at substantially the same elevation as a cover plane containing the cover sheet in the book block.

The nozzle apparatus can include a first adhesive nozzle to direct a first stream of adhesive toward the binding plane along the first adhesive axis, and a second adhesive nozzle, spaced apart from the first adhesive nozzle, to direct a second stream of adhesive toward the binding plane along the second adhesive axis.

The first adhesive nozzle and the second adhesive nozzle can be simultaneously operable so that the first adhesive stream and the second adhesive stream are simultaneously sprayable.

The first adhesive nozzle and second adhesive nozzle can be continuously operable while the adhesive applicator translates between the first and second positions.

When the adhesive applicator is in the first position, the second adhesive axis can intersect the binding plane at a higher elevation than the base plane.

When the adhesive applicator is in the second position, the first adhesive axis can intersect the binding plane at a lower elevation than the cover plane.

The first nozzle can be at a lower elevation than the second nozzle in the first direction.

The second adhesive axis can intersect the first adhesive axis.

The binding plane can be between the point of intersection of the first adhesive axis and second adhesive axis and the adhesive applicator.

According to another broad aspect of the invention, a batcher unit for a book block finishing machine can include at least one receiving member to receive a plurality of sheets and stack the plurality of sheets into a book block. The batcher unit can also include a shuttle apparatus associated with the receiving member and can have a clamp mechanism to clamp the book block. The shuttle apparatus can be moveable in a machine direction to translate the clamped book block between an upstream position and a downstream position. The clamp apparatus can include a first clamp member, having at least two first clamp surfaces to contact a cover sheet of the book block, and at least one first relief surface spaced apart from the first clamp surfaces in a first direction and disposed between adjacent ones of the first clamp surfaces in the machine direction. The clamp apparatus can also include an opposed second clamp member having at least one second clamp surface to contact an opposed base sheet of the book block. The first clamp member can be positionable so that when an adhesive applicator is positioned to apply adhesive to an edge of the cover sheet the at least one first relief surface is aligned with the adhesive applicator to inhibit the adhesive being applied to the edge of the cover sheet from contacting the first clamp surfaces.

The second clamp member can include at least two second clamp surfaces and at least one second relief surface spaced apart from the second clamp surfaces in the first direction and disposed between adjacent ones of the second clamp surfaces in the machine direction. The second clamp member can be positionable so that when an adhesive applicator is positioned to apply adhesive to an edge of the base sheet the at least one second relief surface is generally aligned with the adhesive applicator to inhibit the adhesive being applied to the edge of the base sheet from contacting the second clamp surfaces.

When the second relief surfaces are in contact with the base sheet the at least one second relief surface can be spaced apart from the base sheet.

When the first clamp surfaces are in contact with the cover sheet the at least one first relief surface can be spaced apart from the cover sheet by a first relief clearance distance.

The at least one first relief surface can include at least two first relief surfaces spaced apart from each other in the machine direction by a relief spacing distance. The relief spacing distance can be generally equal to a pitch of oscillation of the adhesive applicator.

The first clamp member can define a first clamp length in the machine direction. A relief length of the at least one first relief surface can be between about 5% and about 25% of the first clamp length.

The at least one first surface can be an arcuate surface and the first relief clearance distance can vary along the length of the first relief surface.

The at least one first relief surface can be offset from the at least one second relief surface in the machine direction by a relief offset distance.

The relief offset distance can be about 50% of the first relief spacing distance.

The at least one first relief surface can oppose one second clamp surface, and the at least one second relief surface can oppose one first clamp surface.

The first relief length can be less than a second clamp surface length in the machine direction.

At least one first relief surface can be an inclined surface. The inclined surface can include a first edge adjacent the cover sheet and a second edge spaced apart from the first edge. The second edge can be disposed between the first edge and the binding plane in the lateral direction.

A relief plane containing the inclined surface may intersect the binding plane and the cover sheet.

According to another broad aspect of the invention a batcher unit for a book block finishing machine can include at least one receiving member to receive a plurality of sheets and stack the plurality of sheets into a book block having a base sheet, an opposed cover sheet and a plurality of intermediate sheets disposed therebetween. The batcher unit can also include at least one adhesive applicator to apply adhesive to binding edges of the plurality of sheets to bind together the book block. The at least one adhesive applicator can be moveable in a first direction between a first position to apply adhesive to an edge of the cover sheet a second position to apply adhesive to an edge of the base sheet. The batcher unit can also include a shuttle apparatus associated with the receiving member and having a clamp mechanism to clamp the book block. The shuttle apparatus can be moveable in a machine direction to translate the clamped book block past the at least one adhesive applicator as adhesive is being applied. The clamp apparatus can include a first clamp member having at least two first clamp surfaces to contact the cover sheet of the book block, and at least one first relief surface spaced apart from the first clamp surfaces in a first direction and disposed between adjacent ones of the first clamp surfaces in the machine direction. The clamp apparatus can also include an opposed second clamp member having at least one second clamp surface to contact the opposed base sheet of the book block. Movement of the shuttle apparatus and adhesive applicator can be coordinated so that when the at least one adhesive applicator is positioned to apply adhesive to the binding edge of the cover sheet the at least one first relief surface is aligned with the adhesive applicator to inhibit the adhesive being applied to the binding edge of the cover sheet from contacting the first clamp surfaces.

### DRAWINGS

For a better understanding of the applicant's teachings described herein, reference will now be made, by way of example only, to the accompanying drawings which show at least one exemplary embodiment, and in which:

FIG. 1 is an isometric view of a book block finishing machine;

FIG. 2 is an isometric view of a portion of a batcher unit;

FIG. 3 is a side view of the batcher unit of FIG. 2 with a book block received in a hopper;

FIG. 4 is a side view of the batcher unit of FIG. 3 with the book block moved downstream of the hopper;

FIG. 5 is a partial isometric view of another example of a batcher unit;

FIG. 6 is a section view taken along line 6-6 in FIG. 5 with a shuttle in an upstream position and the adhesive applicator removed; and

FIG. 7 is a section view taken along line 6-6 in FIG. 5 with the shuttle in a downstream position.

FIG. 8 is a perspective view of a portion of another embodiment of a batcher unit;

FIG. 9 is a perspective view of an adhesive applicator that can be used with the batcher unit of FIG. 8;

FIG. 10 is a perspective view of a portion of the batcher unit of FIG. 8 identified as region 10, with a shuttle in a first position and a glue head in a lowered position;

FIG. 11 is a side elevation view of the portion of the batcher unit of FIG. 10;

FIG. 12 is a perspective view of a portion of the batcher unit of FIG. 10, with the shuttle in a second position and the glue head in a raised position;

FIG. 13 is a side elevation view of the portion of the batcher unit of FIG. 12;

FIG. 14 is a perspective view of a portion of the batcher unit of FIG. 10, with the shuttle in a third position and the glue head in the lowered position;

FIG. 15 is a side elevation view of the portion of the batcher unit of FIG. 14;

FIG. 16 is a perspective view of a portion of another example of a batcher unit, with a book block in the downstream position and the adhesive applicator removed;

FIG. 17 is a section view taken along line 17-17 in FIG. 16, with the shuttle apparatus in an upstream position and the adhesive applicator removed;

FIG. 18 is the section view of FIG. 17 with the shuttle apparatus in a downstream position;

FIG. 19 is an enlarged view of an adhesive applicator applying adhesive to a book block secured in a clamping mechanism;

FIG. 20 is an enlarged view of region A in FIG. 19;

FIG. 21 is an enlarged view of region B in FIG. 19;

FIG. 22 is an end view of the adhesive applicator and clamping mechanism of FIG. 19 with the adhesive applicator in a lower position and the nozzles arranged in a first position;

FIG. 23 is an end view of the adhesive applicator and clamping mechanism of FIG. 19 with the adhesive applicator in an upper position and the nozzles arranged in a first position;

FIG. 24 is another end view of the adhesive applicator and clamping mechanism of FIG. 19 with the adhesive applicator in a lower position and the nozzles arranged in a second position;

FIG. 25 is another end view of the adhesive applicator and clamping mechanism of FIG. 19 with the adhesive applicator in an upper position and the nozzles arranged in a second position;

FIG. 26 is an end view of another example of an adhesive applicator applying adhesive to a clamped book block;

FIG. 27 is a perspective view of another example of an adhesive applicator applying adhesive to a clamped book block;

FIG. 28 is an enlarged view of a portion of the adhesive applicator of FIG. 27; and

FIG. 29 is an end view of the adhesive applicator of FIG. 27.

Elements shown in the figures have not necessarily been drawn to scale. For example, the dimensions of some of the elements may be exaggerated relative to other elements. Further, where considered appropriate, reference numerals may be repeated among the figures to indicate corresponding or analogous elements.

### DETAILED DESCRIPTION

Various apparatuses or processes will be described below to provide an example of an embodiment of each claimed invention. No embodiment described below limits any claimed invention and any claimed invention may cover processes or apparatuses that differ from the exemplary embodiments described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

As described herein, a book block finishing machine can be any machine that is operable to stack a plurality of printed sheets into one or more book blocks. Generally, the incoming printed sheets are advanced on a conveyance in a machine direction (i.e., the general direction of travel of the web and/or sheets), and are collected and stacked in a receiving member to form a book block. One example of a suitable receiving member is a hopper, as described below. The direction generally orthogonal to the machine direction can be referred to as the lateral or transverse direction.

For the purposes of this description, a book block comprises a plurality of sheets of paper, stacked in order, temporarily bonded together and generally taking the form of a book without a cover or other permanent binding. Book blocks may be formed having a variety of physical dimensions (length and width) based on the requirements of the finished book (i.e., paper back, hardcover, coffee table book, etc.) and may contain a variety of numbers of pages depending on the length of the book being printed. Varying the number of pages in a book block may vary the height of the book block. While the term book block is generally used in this description to describe a plurality of pages arranged in order to form the text of a book, it is understood that the term book block also refers more generally to any collection of stacked sheets or pages, the contents of which may be a book or any other type of printed media, including flyers, catalogues, directories and manuals.

The incoming sheets that will form the book block can be initially supplied to the book block finishing machine as individual sheets, or as a generally continuous, moving web of paper (or other suitable material) upon which desired text and/or graphics is printed. Such an incoming web can then be separated into a plurality of sheets, which can then be arranged into one or more steams of sheets moving through the machine. Each stream of sheets can be fed into a hopper, in which the sheets are stacked to form the book block.

Optionally, the book block finishing machine may be configured to operate in an “on-line” capacity, in which the incoming web is received from a printing engine (digital or offset) in real time (i.e. the printed web exiting the printing press is fed into the book block finishing machine). Alternatively, the book block finishing machine may be configured to operate in an “off-line” capacity in which the incoming web is unwound from a spool or roll of pre-printed material, as opposed to coming directly from the output of a printing press. In either example, the web can be supplied to the book block finishing machine at a given linear velocity or web speed that can be expressed in absolute terms, for example the web can be traveling at ten linear feet per second, or in relative terms, for example the web and/or sheets can be traveling between about 400 and 800 sheets per minute (which may represent a variety of different velocities depending on the length of each sheet), or greater than 800 sheets per minute.

An example of such a book block finishing machine is the book block finishing machine described in PCT/CA2010/000832 (Speller et al.), filed Jun. 1, 2010 and entitled “Book Block Finishing Machine,” the entirety of which is incorporated herein by reference.

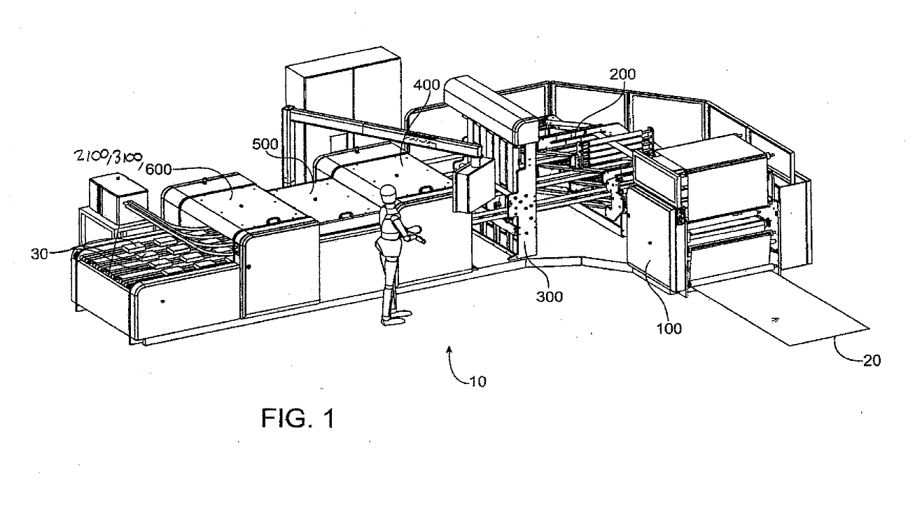

Referring to FIG. 1, one example of a book block finishing machine 10, including a forming unit, for example slitting unit 100, a ribbon shifting unit 200, a compensator unit 300, a sheeting unit 400, a shingle and interrupt unit 500 and a batcher unit 600. The book block finishing machine 10 is configured to receive an incoming web 12 and to convert the incoming web 12 into a plurality of book blocks 14. The incoming web 12 is advanced through the book block finishing machine 10 in a longitudinal or machine direction which is represented in the present figures by arrow 16. The direction generally orthogonal to the machine direction can be referred to as the lateral or transverse direction.

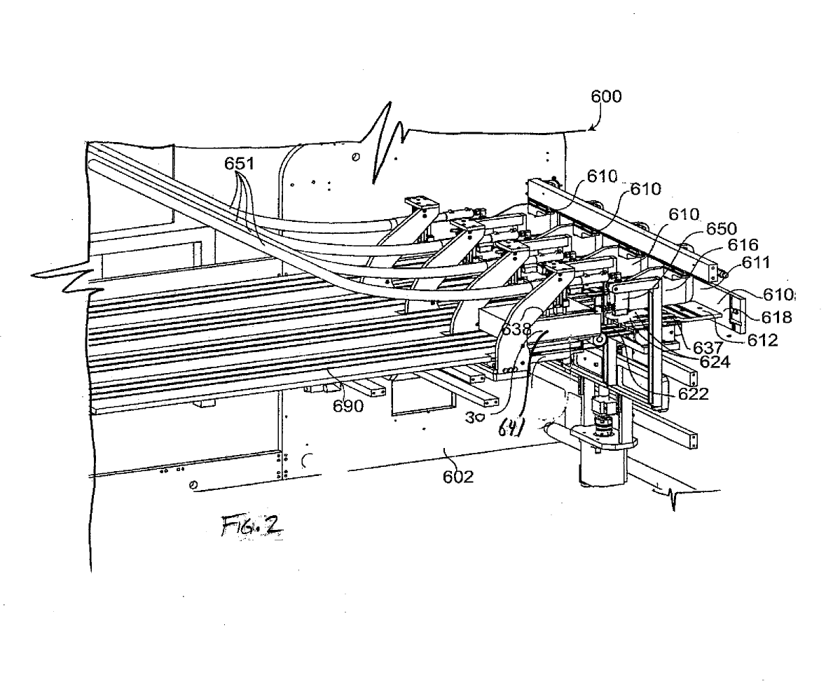

Referring to FIG. 2, one example of a batcher unit 600a suitable for use with the book block finishing machine 10 includes a plurality of batch hoppers 610 within which a plurality of sheets for a given print job (i.e. a single copy of the book being printed) are stacked to create a book block 30 having the desired number of pages of the finished product (optionally ranging from a few sheets to several hundred pages). The batcher unit 600a is illustrated with portions of its frame, cover and sidewalls removed for clarity, to reveal the inner components of the unit 600a.

The batcher unit 600 also includes a shuttle 630 and a moveable adhesive applicator mechanism having a nozzle apparatus, including a glue head 650, for each hopper 610. In other examples, the batcher unit 600 can include a different number of adhesive applicator mechanisms, for example a single adhesive applicator could be moveable such that it could be used to provide glue on multiple book blocks (as described below).

During a batching sequence or batching cycle (i.e. the cycle of making one completed book block) the desired number of sheets are fed from the shingle and interrupt unit 500 into one of the hoppers 610 of the batcher unit 600. Each stream of sheets generally flows or feeds into a corresponding hopper 610. The present example of the batcher unit 600 is illustrated having four hoppers 610, for receiving up to four streams of sheets 24 formed from up to eight ribbon 22 streams (some or all of the streams of sheets 24 being stacked ribbon streams). It is understood that other examples of the batcher unit 600 may include a greater or fewer number of hoppers 610 (and related hardware described in detail below).

Each hopper 610 includes an interior volume 611 defined by a bottom support, for example bottom 612, a moveable side wall 614, a fixed sidewall 616, a rear support, for example a fixed upstream end wall 618 and a moveable gate 620 forming the downstream end of the hopper. The fixed sidewall 616 of each hopper 610 can be aligned with one of the reference positions to which the ribbon streams were justified by the ribbon shifting unit 200. Aligning the reference positions with the locations of the fixed side walls 616 may allow each stream to be accurately received within its corresponding hopper 610 as both the stream reference edge and the hopper 610 fixed side wall 616 are aligned with a corresponding reference position.

Optionally, within each batch hopper 610, as the individual sheets are fed into the hopper 610 the sheets can be vibrated (or jogged) by oscillating a side jogger, for example the movable side wall 614 at a relatively high frequency or other known jogging techniques to create aligned book blocks 30, and so that the completed book blocks 30 are registered or justified to one side of the hopper 610 (generally against the fixed side wall 616). Also, the movement of the moveable side wall 614 can be programmable to operate differently as the book block is created. For example the movable side wall 614 may oscillate in a slightly open setting (i.e. centered about a position that is slightly wider than transverse the width of the expected book block) so as to not pinch the sheets 24 are flowing into the hopper 610. Once all the sheets 24 that make up a given book block are in the hopper 610 and the flow is interrupted, the movable side wall 614 can shift inward and oscillate tighter against the book block to perform a final jog to even up book block edges.

In the illustrated example, the bather unit 600 may include several hoppers 610 operating in parallel with each hopper 610 accepting the sheets 24 from a given ribbon 22, and the book blocks 30 within each hopper may be justified in the same manner (i.e. to the right side in every hopper 610). By adjusting the range of movement of the moveable side wall 614 and the longitudinal position of the gate 620 each hopper 610 can be reconfigured on the fly to accommodate book blocks 30 of differing length, width and page number.

After all the sheets 24 of a book are stacked in the hopper 610 they are considered to have formed a stack or book block 30. The incoming sheet stream is interrupted or arrested to stop any additional sheets 24 from flowing into the hopper 610. When the book block 30 is completed it is clamped by a clamping mechanism, including the upper and lower clamp plates 638, 636, of a movable shuttle 630. The floor 612 of each hopper 610 includes a slot 637 for receiving the lower clamp 636 of the corresponding shuttle 630.

To clamp the book block 30 both clamp plates 636, 638 move from their respective first or retracted positions to their second or extended positions (or clamped positions). The retracted position of the lower clamp 636 is lower than the floor 612 of the hopper 610 and the extended position of the lower clamp 636 is proud of the floor 612 of the hopper 610 so that the lower clamp 636 can be moved into the slot below the book block 30 without disturbing the bottom sheet of the book block 30 and, when the lower clamp plate 636 is extended it lifts the book block 30 proud of the floor 612 of the hopper 610 so that the book block 30 can be moved relative to the hopper 610 without damaging or jarring the bottom sheet of the book block 30. To ensure that the book block 30 is lifted proud of the hopper floor 612, the clamping force of the lower clamp 636 may be greater than the clamping force of the upper clamp 638. Optionally, the clamp plates 636, 638 are positioned slightly inward from the clamped edge of the book block 30, by a clamp spacing distance 639 to reduce the chances of adhesive sprayed by the adhesive applicator (described in detail below) contacting the clamp plates, or other interference issues.

Once the clamp plates 636, 638 have engaged the book block 30, the hopper gate 620 is opened and the shuttles 630 can be moved in the downstream direction, carrying the book blocks 30 out of the hoppers 610. The shuttles 630 may be moved using any suitable actuator including hydraulic and pneumatic cylinders, ball screws, gears, chain drives and belt drives (not shown).

In some examples all the shuttles 630 may move in unison, in other examples each shuttle or a sub-group of shuttles may be moveable independently of the other shuttles. Also, the clamping mechanism has been described as comprising upper and lower clamp plates 638, 636 but it is understood that any suitable clamping mechanism could be used, including variations of the clamp plates having different shapes and sizes and being applied with different forces. The clamping force may be generated using any known means, including hydraulic and pneumatic pressure and mechanical actuators, including actuator 724. Motion and activation of the shuttle 620 and the clamp plates 636, 638 may be controlled by the batcher unit controller or computer and may be based on sensor information.

In the present example, the hopper gate 620 may pivot in a downstream direction to allow the book block 30 to pass over the gate 620 as it exits the hopper 610 and the gate 620 may provide some support for the book block 30 as it moves. In other examples the gate 620 may be slidingly or rotationally connected or may pivot in a direction other than downstream. The gate 620 may be operated by servo motor, electric actuator, pneumatic actuator or other suitable actuator. Further, in the example shown the gate 620 for each hopper 610 includes a plurality of gate fingers 622 received in gate grooves 624 in the floor 612 of each hopper 610. Configuring the gate 620 as a plurality of gate fingers 622 spaced apart across the width of the hopper 610 allows each gate 620 to be operated using all gate fingers 622 for large book blocks 30, or only a portion of the gate fingers 622 when producing narrower book blocks 30. Such a configuration may allow the shuttle 630 and moveable side wall 614 to adjust to produce smaller, narrower book blocks 30 without interfering with or colliding with unneeded portions of a single, unitary gate. However, some examples of the book block finishing machine 10 the gate 620 may be a single gate member. Optionally, the longitudinal position of the gate 620 may be adjustable relative to the walls of the hopper 610 so that the gate 620 (which provides the downstream stop position for sheets 24 received in the hopper 610) can be re-positioned to receive pages of different lengths within the hopper 610.

When the gate 620 on the hopper 610 is opened, the completed book block 30 is clamped to remove air from the book block (as described above) and measured to verify the height/thickness of the finished book using the height sensor 660. The shuttle 630 is then translated downstream, past a glue nozzle 650, until the book block 30 is clear of the hopper 610. Once the clamped book block 30 is clear of the hopper the end gate 620 of the hopper 610 can be closed, the incoming stream of sheets can be resumed (the interrupter or the arrester are released) and a new set of sheets 24 can be stacked within the hopper 610 while the clamped book block 30 is further processed. This may improve the efficiency (reduce the cycle time) of the batching process.

In some examples of the book block finishing machine 10 both side walls 614, 616 of the hoppers 610 may be movable so that the hoppers 610 can be configured to receive sheets of different widths or to allow greater spacing between reference positions. In some examples (when all ribbons are registered to each other) the hoppers 610 and shuttles 630 may be configured together in the same configuration. In other examples (where each ribbon is not registered to its adjacent ribbon(s), each hopper 610 and shuttle 630 may be independently configurable.

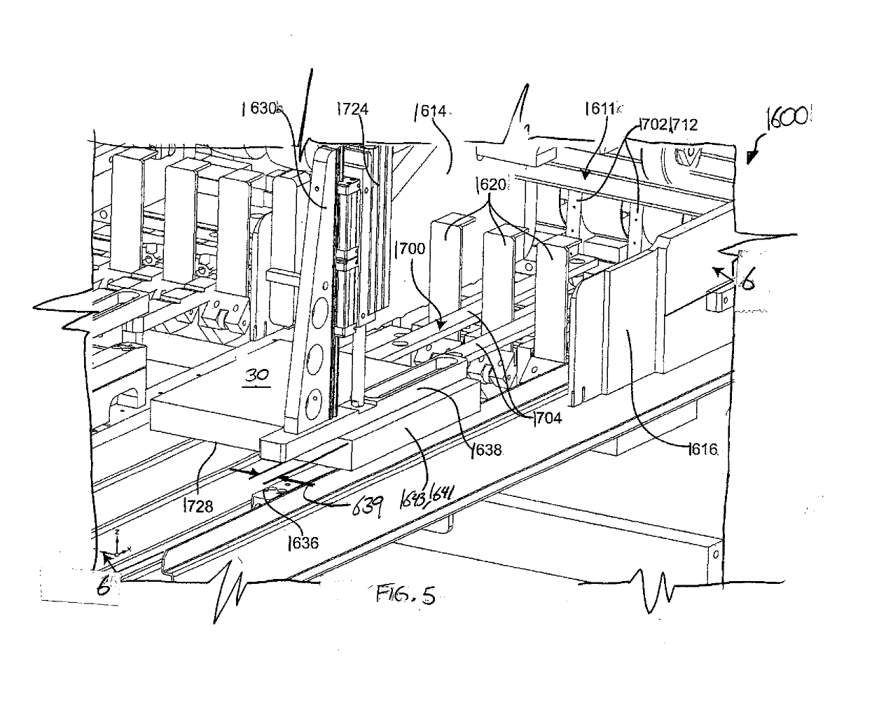

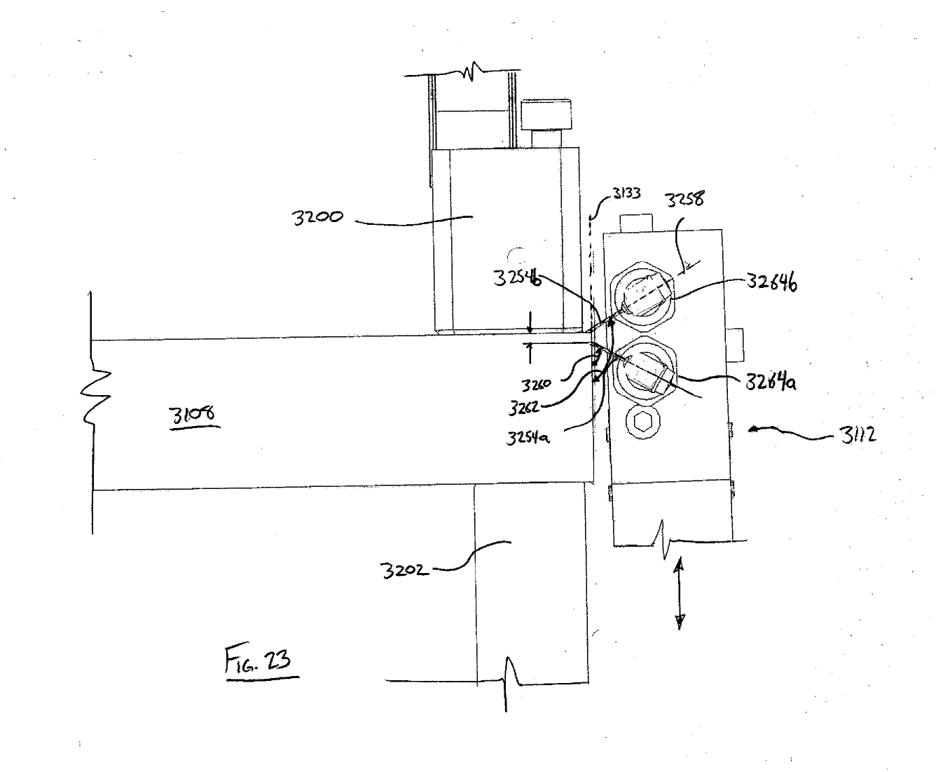

Upon leaving its hopper 610, each book block 30 held within the clamp plates 636, 638 of its shuttle 630 is translated past a gluing station where glue is applied to a binding edge 641 of the book block 30 (for example on the book spine) by the moveable glue nozzle 650. The binding edge of the book block 30 lies in a binding plane 643, which, in the illustrated example, is a generally vertical plane disposed laterally between the clamp plates 636, 638 and the glue nozzle 650 (see FIG. 5, and binding plane 3133 in FIGS. 22-26). The nozzle 650 is configured to direct a stream of glue toward a binding plane 643, and onto the binding edge 641. Applying glue at this stage in the book manufacturing process may provide the means to secure or bind the book block 30, keeping it intact for further handling.

To apply the glue, the batcher unit 600 is configured to impart relative movement between the book block 30 and an adhesive applicator, which in this example includes the glue nozzle 650. In the described examples the clamped book block 30 is advanced horizontally translated past the movable glue nozzle 650 and as the book block 30 moves past the glue nozzle 650 (horizontally in the illustrated example) the glue nozzle 650 translates in a direction orthogonal to the book block movement (vertically in the illustrated example).

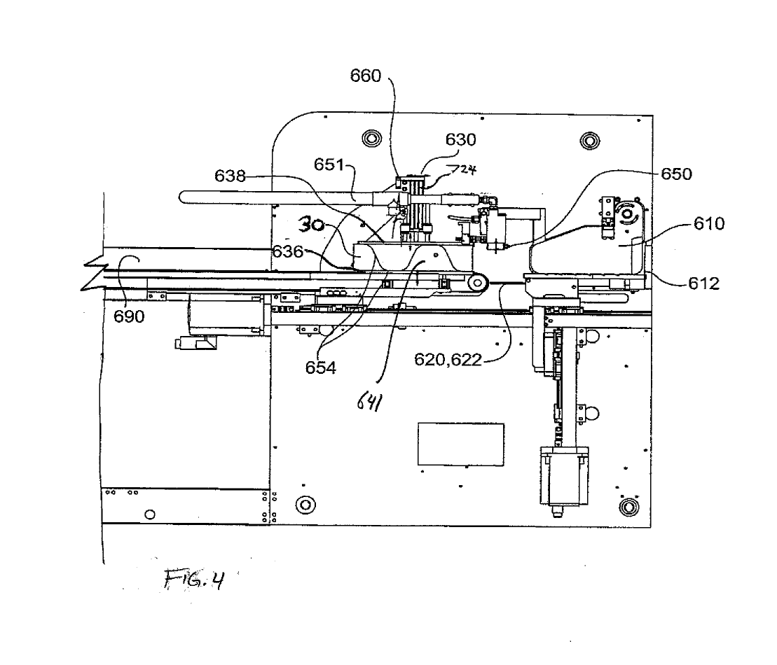

The resulting combination of horizontal and vertical movement of the book block 30 and the glue nozzle 650 respectively produces a bead of adhesive 654 that traces a path across the binding edge 641 of the book block 30. In some examples the path may resemble a sine curve, and in other examples the relative speeds of the book block 30 and the glue nozzle 650 can be adjusted so that the adhesive bead traces a modified sine curve pattern having extended pauses at the peaks in order to apply extra adhesive to the top and bottom pages in the book block 30, as shown in FIG. 4.

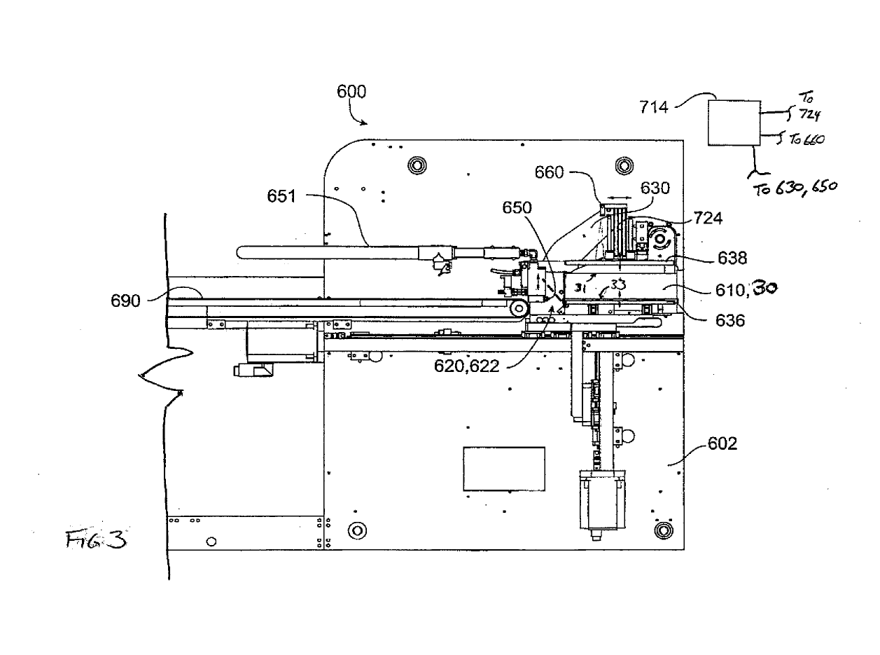

Optionally, the shuttle 630, clamp plates 636, 638 and glue nozzle 650 can be communicably connected to a batcher unit controller 714 (illustrated schematically in FIG. 3) that can automatically control the operation of these elements in the manner described. The batcher unit controller 714 can be a combination of both hardware and software and can be configured as a stand-alone controller or integrated as a module in another controller.

Referring to FIG. 3, optionally, the range of motion of the glue nozzle 650 is adjustable and can be set based on the dimensions of the book being printed and the height information obtained using height sensor 660. Determining the height of a clamped book block 30 using the height sensor 660 (acoustic, or laser or any other suitable sensor) may be advantageous as it can be used to calculate a motion profile for the shuttle 630 and glue nozzle 650. The range of motion can be selected so that glue is applied to all of the sheets in the book block 30, including a lowermost or base sheet 31 and an uppermost or cover sheet 33. Preferably, the vertical travel of the glue nozzle 650 can be limited so that glue is not intentionally sprayed above cover sheet 33 or below the base sheet 31. Limiting travel of the glue head 650 in this manner may help reduce adhesive waste and may prevent the glue nozzle 650 from apply glue to unwanted area of the book block 30 or the batcher unit, including for example the clamping mechanism. The height sensor 660 can also be connected to the batcher unit controller 714.

This combination of book block translation and adjustable glue nozzle 650 translation allows the glue nozzle to easily and quickly adapt to different book block 30 sizes on the fly, which may not be possible using a traditional fixed nozzle or slotted extrusion type glue nozzle.

Glue/adhesive can be stored within the glue head 650 or supplied from an external source (not shown) by a glue supply line 651.

Once the glue is set to a desired set point, the clamp plates 636, 638 can release the book block 30 onto a book block conveyor, for example conveyor belt 690. The resilient properties of the glue may serve to keep the book block 30 intact during transport while still allowing the flexibility required for subsequent handling and processing. The glued book block is then moved down a conveyor belt 690 for further processing. In the present example, the adhesive applied to the book block 30 in the batcher unit 600 is a temporary adhesive that is not intended to remain on the final product.

The adhesive applied to the book blocks 30 by the batcher unit 600 can be described as a temporary adhesive because in some examples it is not intended to remain on the book block 30 after the book block 30 has been covered and bound as a finished book. In such example, the edge of the book block 30 that has been treated with adhesive is subsequently trimmed or shaved off prior to binding the book block 30 into a finished book. That is, in some examples, before the book block 30 is bound with its finishing cover the glued edge may be trimmed off to provide a clean, straight edge for attachment to the book spine. In these examples, the term temporary adhesive is understood to mean an adhesive that is applied to the book blocks 30 to help stabilize them during subsequent processing but that is removed (by trimming or any other method) prior to attaching a cover to the book block 30.

In other examples, the spine or cover may be attached over the existing glued edge.

Referring to FIGS. 5-7, another example of a batcher unit 1600 includes hoppers 1610 having interior volumes 1611 for receiving a plurality of sheets. Batcher unit 1600 is generally similar to batcher unit 600, and like elements are identified using like numerals indexed by 1000. To better illustrate the internal components of the batcher unit 1600, portions of the housing (including sidewalls, covers, etc.) are removed, and the drawings are generally limited to an example of a single hopper 1610. The features described with reference to this exemplary hopper 1610 can apply to other hoppers 1610 in the batcher unit 1600, and can be used with compatible features of other batcher units.

In this example, each interior volume is defined by a moveable side wall 1614, fixed sidewall 1616, a bottom support 1700 a rear support 1702 and a moveable gate 1620 provide toward the downstream end of the hopper 1610.

In this example, the bottom support 1700 that supports the plurality of sheets received within the hopper 1610 includes a pair of spaced apart support members or rails 1704 and the lower clamp plate 1636. In this example the lower clamp 1636 is not extendible or moveable relative to the moveable shuttle 1630. Using the rails 1704 and lower clamp plate 1636 to support the stacked sheets, i.e. the book blocks, within the hopper 1610 may reduce the need to include a solid bottom wall or floor on each hopper 1610. Optionally, the rails 1704 can be positioned at a slightly higher elevation than the lower clamp plate 1636 so the sheets received in the hopper 1610 define a slightly curved or arcuate profile in the transverse direction. Such a curved profile in stacked sheets can increase the rigidity of the sheets which may be helpful when handling light weight papers.

As the plurality of sheets are fed into the hopper 1610 they can be jogged by oscillating the moveable side wall 1614.

The illustrated example also includes a rear support 1702 that is formed from a plurality of pivotable, oscillating support fingers 1712, defining a rear jogger that can jog the book blocks in the longitudinal direction. While the illustrated example includes two support fingers 1712 per hopper 1610, any number of fingers could be used, and optionally that individual fingers could be replaced with a solid plate if desired.

Providing an oscillating rear support 1702 may help facilitate the jogging the book blocks in both the longitudinal and transverse directions. This may help create even, smooth surfaces on each side of the book block 30.

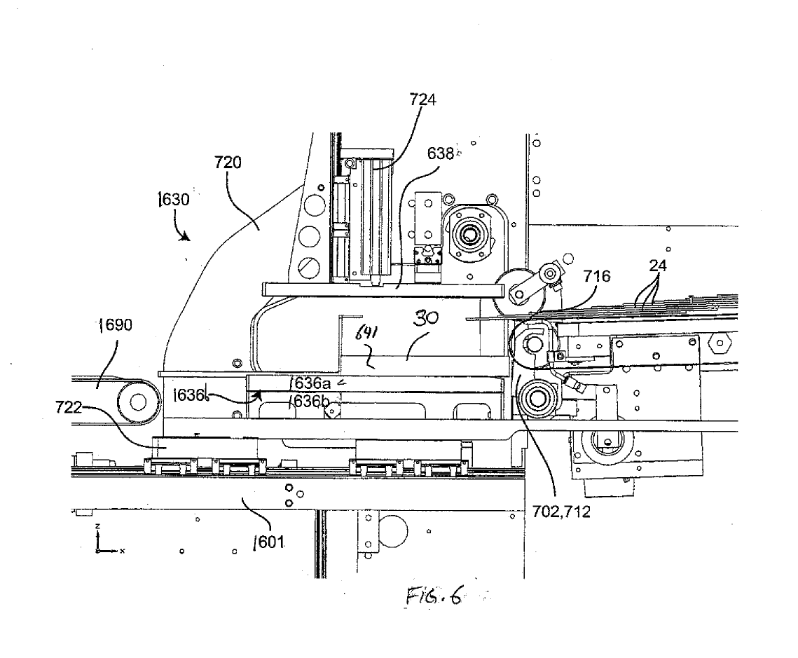

Referring to FIG. 6, optionally, the hoppers 1610 can be configured to include a nozzle 1716 that is configured to supply air (or any other suitable fluid from a fluid supply—not shown) into the hopper 1610 as the individual sheets 24 are fed into the hopper 1610. Providing a supply of air between the sheets may help inhibit interference between sequential sheets and reduce the chances of jamming, binding or misalignment between sequential sheets 24 entering the hopper 1610, and may enable subsequent sheets 24 to float or gently settle onto the preceding sheets 24 retained in the hopper 1610. Optionally, the air can be ionized to reduce the build-up of static charge between sheets. The nozzle 1716 can be configured to continuously supply a steady stream of air, or to provide separate puffs of air, that may be synchronized with the movement of the sheets.

In this example, the lower clamp plate 1636 is fixedly connected to the moveable shuttle 1630 to move with the shuttle 1630 between upstream and downstream positions. The lower clamp plate 1636 is moveable in the vertical direction (as illustrated) and does not move between retracted and extended positions. Instead of being extendible in the vertical direction to clamp the book block 30, in the illustrated example, the lower clamp plate 1636 is positioned so that it is at a desired level relative to the rails 1704 and ledge 1706, and remains in this position until adjusted by a machine operator. Preferably, the upper surface of the clamp plate 1636 is generally flush with the upper surfaces of the rails 1704. Optionally, the lower clamp plate 1636 is formed from two separate members, 1636a and 1636b that can be adjusted relative to each other. This relative adjustment, for example using a set screw or other fastener, allows an upper surface of member 1636a to be leveled (i.e. arranged horizontally) and positioned at a desired elevation without requiring the adjustment of member 1636b, or other portions of the shuttle 1630 or batcher unit 1600.

In the illustrated example, the shuttle 1630 includes an upper frame member 1720 that is connected to a lower frame member 1722. Optionally, the upper and lower frame members 1720, 1722 can be a single continuous member. The lower frame member 1722 is slidably or translatably mounted to the frame 1602 of the batcher unit 1600, for example on a plurality of parallel rails 1601. The lower frame 1722 can be connected to the rails 1601 using any suitable means.

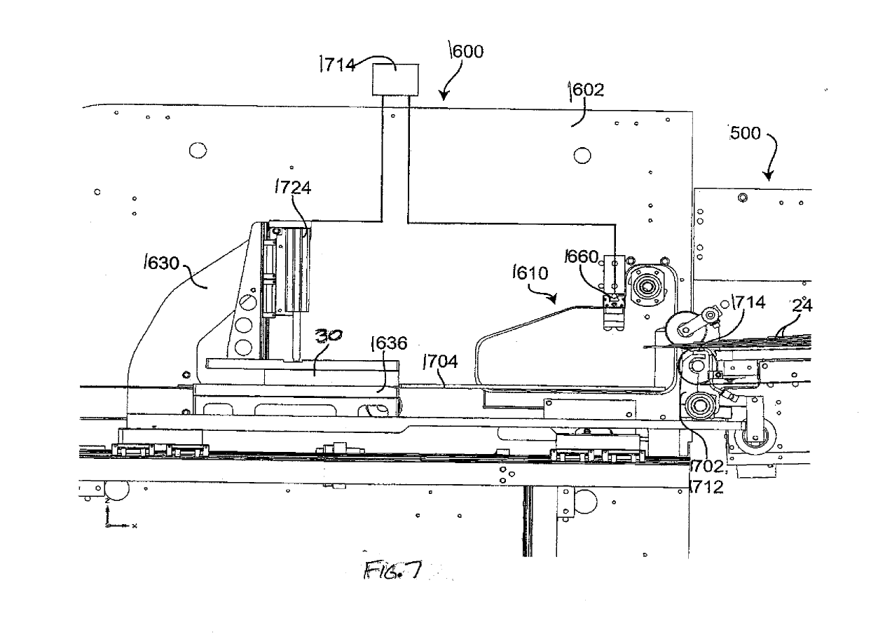

The upper frame member 1720 can be curved as shown, or any other suitable shape that enables the upper clamp plate 1638 to be positioned in the desired location. The upper frame member 1720 also supports the upper clamp plate 1638 and a clamp actuator 1724, which is used to move the upper clamp plate 1638 between its retracted position (as shown in FIG. 6) and its extended position (as shown in FIG. 7). In this configuration, the clamp actuator 1724 is translatable with the shuttle 1620, between the upstream (as shown in FIG. 6) and downstream (as shown in FIGS. 5 and 7) positions. Each clamp actuator 1724 can be connected to the batcher unit controller 1714 so that each clamp can be trigger automatically based on any suitable criteria, including, for example, book block height data received from height sensor 1660. In other examples, the clamp actuator 1724 and shuttle 1630 can be automatically triggered after a certain number of sheets 24 have entered the hopper 1610, or after a certain time has passed (foe example, once every 5 seconds).

As mentioned above, in the illustrated example the shuttle 1630 is a single member that extends across the transverse width of the batcher unit 1600. The shuttle 1630 can include any suitable number of upper frame members 1720 and can support any suitable number of clamp actuators 1724 and upper clamp plates 1638, for example one of each per hopper 1610.

Optionally, the hopper gates 1620 can be translatable in the transverse direction so that they are generally aligned with the centre of the particular book blocks being formed by the batcher unit 1600. For example, if the book blocks 30 being formed have a transverse width 1726 of 4 inches, the hopper gate 1620 can be positioned so that it is centered 2 inches from the fixed side wall 1616, which is aligned with a given reference position, which can be coincident with the binding plane 643, of the book block finishing machine 10. For example, if the next book block 30 to be formed by the batcher unit 600 has a width 1726 of 10 inches, the hopper gate 1620 can be translated so that it is centered 5 inches from the fixed side wall 1616.

Optionally, the movement of the hopper gates 1620 can be related to the movement of the moveable side walls 1614 (which are also repositioned to accommodate book blocks of differing widths) or the hopper gates 1620 can be moved independent of the moveable side walls 1614. Movement of the hopper gates 1620 can be automatically controlled by the batcher unit controller.

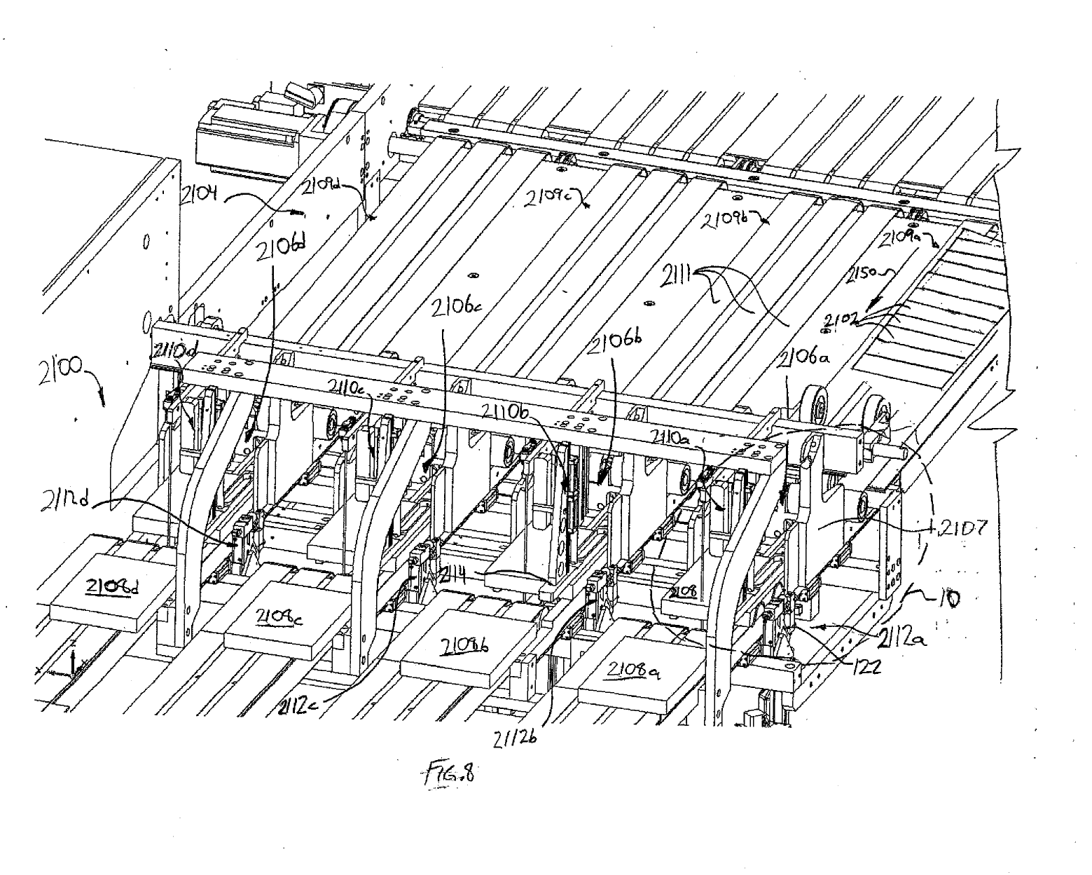

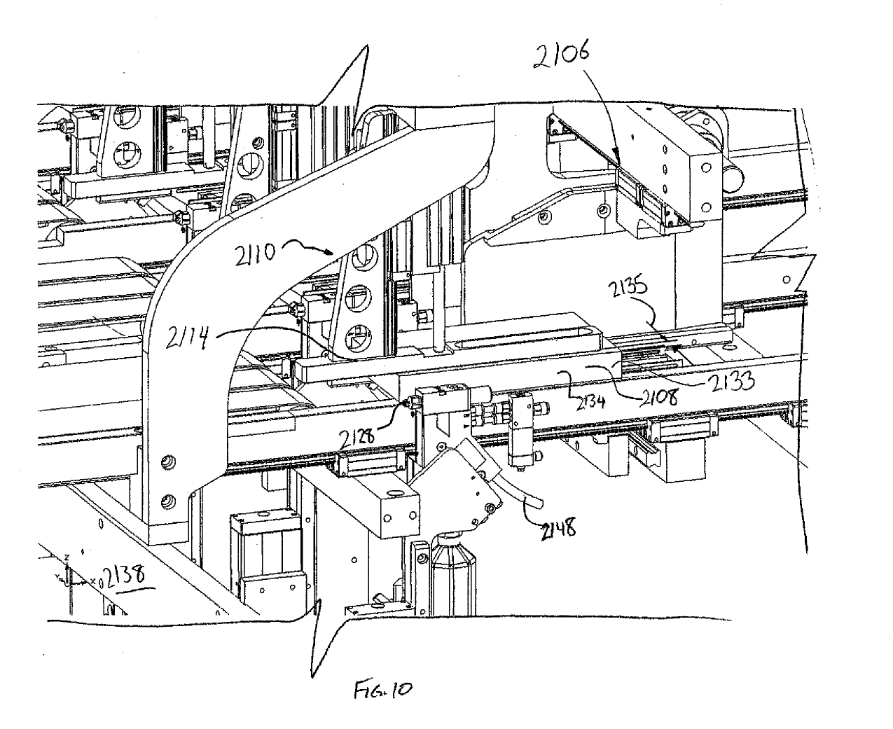

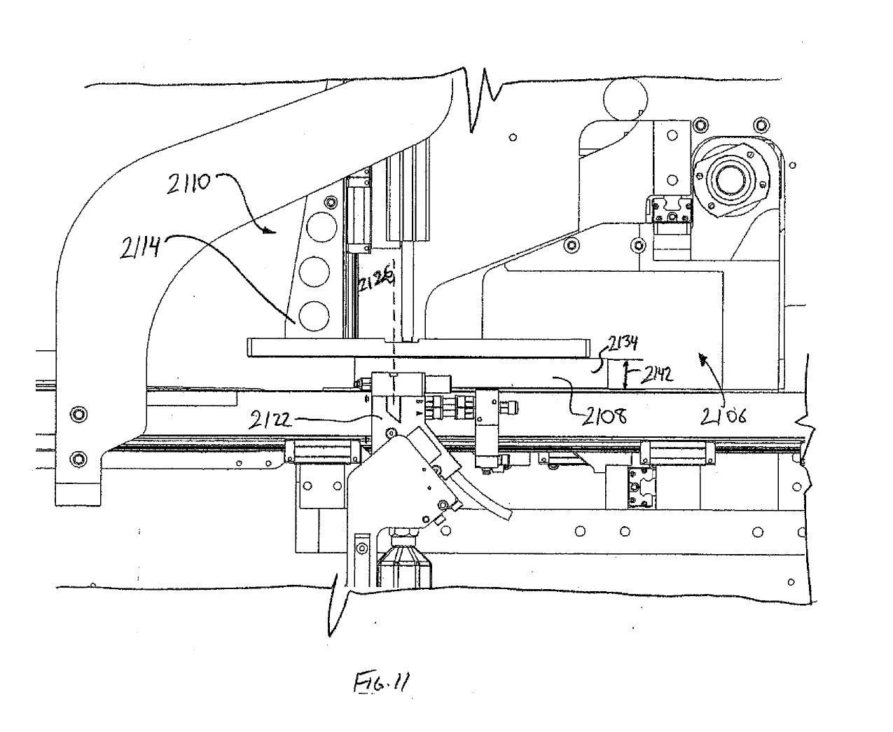

Referring to FIG. 8 another example of batcher unit 2100 that is suitable for use in a book block finishing machine 10 is illustrated. Optionally, the batcher unit 2100 can be provided as a discrete, or stand-alone unit that can co-operate with, or replace, other discrete units or modules in the book block finishing machine. Alternatively, the batcher unit 2100 can be incorporated as a sub-unit or sub-assembly within another unit in the book block finishing machine. In this example, the batcher unit 2100 is configured to receive a plurality of sheets 2102 from an upstream portion of the book block finishing machine, for example, feed conveyor 2104 that may form part of a shingle and interrupt unit, to stack the sheets 2102 within hoppers 2106 to form book blocks 2108 (FIGS. 10 and 11). Optionally, the sheets supplied to the batcher unit can be folded in the web direction. For example, incoming sheets can be folded in half, thirds or spline folded based on the nature of the printed content on the sheets.

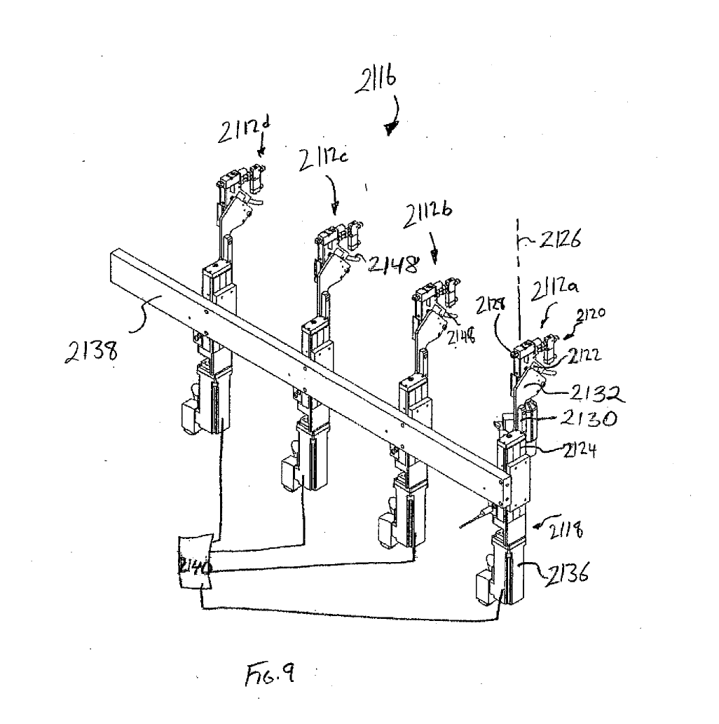

In FIGS. 9-15, portions of the book block finishing machine, including the near side wall 2107 of the hopper 2106, have been removed so that other features of the batcher unit 2100 adhesive applicator can be more clearly illustrated. It is understood that such removed components would be replaced when assembling and operating the batcher unit and the book block finishing machine.

Referring to FIG. 8 the batcher unit 2100 is a multi-stream batch unit that includes a plurality of batch hoppers 2106a-d within which a plurality of sheets 2102 for a given print job (i.e., a single copy of the book being printed) are stacked to create book blocks 2108a-d having the desired number of pages of the finished product (optionally ranging from a few sheets to several hundred pages). The batcher unit 2100 also includes a plurality of shuttle apparatuses 2110a-d and moveable adhesive applicator mechanisms 2112a-d associated with hoppers 2106a-d. Each shuttle apparatus 2110a-d is operable to transport completed book blocks 2108a-d from respective hoppers 2106a-d for further processing. In the illustrated example, each of shuttle apparatuses 2110a-d includes a clamp mechanism 2114a-d that is configured to squeeze the book blocks 2108a-d in a vertical direction.

The illustrated example of the batcher unit 2100 is illustrated having four hoppers 2106a-d, for receiving up to four streams of sheets. The sheets 2102 are provided as shingled streams (shown on the left side of FIG. 8) that are conveyed on conveyor portions 2109a-d, of the feed conveyor 2104. Each conveyor portion 2109a-d includes three, spaced apart conveyor belts 2111. Other examples of the batcher unit 2100 may include a greater or less number of hoppers (and all related hardware). For simplicity, this description will describe the operation of the batcher unit 2100 with respect to a single stream of sheets 2102 entering a single hopper, hopper 2106a.

Referring to FIG. 9 an embodiment of an adhesive applicator 2116 for use on the batcher unit 2100 comprises four adhesive applicator mechanisms 2112a-d. Optionally, each adhesive applicator mechanism 2112 can be operable independently from the other adhesive applicator mechanisms 2112.

In the illustrated example, each adhesive applicator mechanism 2112 includes a stationary portion 2118 and an adhesive applying portion. In the illustrated example, the adhesive applying portion comprises a moveable portion 2120 that is adapted to apply adhesive to the book blocks 2108. In the illustrated example, the moveable portion 2120 includes nozzle apparatus having a glue head module 2122 that is slidably mounted on a vertically oriented linear bearing 2124, so that the glue head module 2122 can translate in the vertical direction, along a translation axis 2126. The glue head module 2122 includes a glue nozzle 2128 that is coupled to a support member 2130 using a bracket 2132. The size and shape of the support member 2130 and the bracket 2132 can be selected based on the configuration of the hoppers 2106, so that the glue nozzle 2128 can be positioned adjacent the binding plane 2133, containing the binding edge 2134 (FIGS. 10-15) of a book block 2108 being removed from the hoppers 2106.

The glue nozzle 2128 can be any suitable glue nozzle, including a slot-type glue nozzle.

The stationary portion 2118 of the adhesive applicator mechanism 2112 includes the linear bearing 2124 and an actuator 2136 for moving the moveable portion 2120 in the vertical direction. The actuator 2136 can be any suitable type of linear actuator that can drive the moveable portion 2120, including a servo motor driving a ball screw, and a pneumatic cylinder.

The stationary portions 2118 of the adhesive applicator mechanisms 2112 are mounted on a lateral beam 2138 that is connected to the frame of the batcher unit 2100. The lateral beam 2138 can be sized to provide a desired degree of stiffness, which may help inhibit vibrations and may improve the accuracy of the gluing process. Optionally, the clamping mechanism, such as clamp 2114, can be also constructed to have a high degree of stiffness.

Each actuator 2136 can be connected to a batcher unit controller 2140, and/or a central machine controller (not shown), which can be configured to control the range of motion, and speed (or rate of travel) of each actuator 2136 separately. The actuators 2136 and controller 2140 can also be used to make slight variations in the range of motion between adhesive applicator mechanisms 2112 even when all of the hoppers 2106 are being used to stack the same book (i.e., a block containing the same number of sheets 2102).

For example, the continuous web of paper that is used to form the sheets 2102 can have minor variations in thickness across its width, which may cause slight variations in the height 2142 (FIG. 11) of the stacked book blocks 2108. Also, the edge portions of the web may be slightly more susceptible to curving or developing a wavy profile during the printing process than the central portions of the web. In this instance, a stack of sheets cut from the edge portions of the web may have a slightly greater thickness than a stack of sheets cut from the central portion of the web.

In such circumstances, it may be desirable to increase the range of motion of the outer adhesive applicator mechanisms 2112a,d (located at the left and right when viewed in FIG. 9), relative to range of motion of the inner adhesive applicator mechanisms 1112b,c (the middle two applicators 2112 as illustrated in FIG. 9), even if the stacks contain the same number of sheets. In some examples, such minor variations in range of motion may be the difference between properly gluing all of the sheets in the book block, and failing to properly bond the one or more sheets on the bottom or top of the book block 2108. Even a single missing or misaligned sheet that is not bonded with the adhesive may be undesirable and may interfere with subsequent processing of the book block (for example binding, etc.).

Referring to FIGS. 11-15, during a batching sequence or batching cycle (i.e., the cycle of making one completed book block) the desired number of sheets 2102 are fed from the feed conveyor into a corresponding one of the hoppers 2106 of the batcher unit 2100. When the book block is completed it can be clamped by the clamping mechanism 2114 of the movable shuttle 2110.

Optionally, the clamp grips the book block 2108 slightly inward from the clamped edge 2134, offset by the clamp spacing distance 2135 (FIG. 10), which may help to reduce the chances of adhesive contacting the clamp 2114.

When the clamp 2114 has engaged the book block 2108, the shuttles 2110 can be moved in the downstream direction, carrying the book blocks out of the hoppers 2106. The shuttles may be moved using any suitable actuator including hydraulic and pneumatic cylinders, ball screws, gears, chain drives and belt drives (not shown).

Upon leaving its hopper 2106, each book block 2108 is translated past the adhesive applicator mechanisms 2112, where glue is applied to the binding edge 2134 of the book block 2108 (for example on the book spine) using the glue head module 2122 of adhesive applicator mechanisms 2112. FIGS. 11-15 illustrate a sequential progression of a book block 2108 being translated past a glue head module 2122.

When applying the glue, the batcher unit is configured to impart relative movement between the book block and the adhesive applicator mechanisms in two different directions. In the described examples the clamped book blocks 2108 are horizontally translated past the adhesive applicator mechanisms 2112 while the glue head modules 2122 are translated in a direction orthogonal to the book block movement (e.g. vertically). The range of motion of the glue head module 2122 can correspond to the thickness of the book block 2108. In FIGS. 10 and 11, the book block is in a first position and the glue head module 2122 is in a lowered position, so that the glue nozzle 2128 is generally aligned with the bottom sheet, or sheets, in the book block 2108.

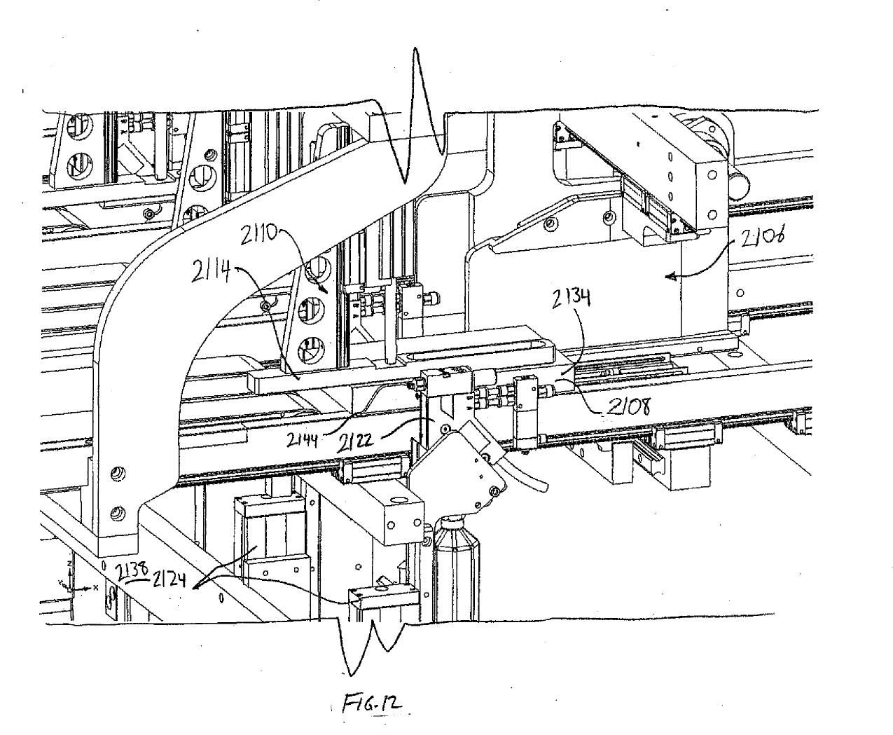

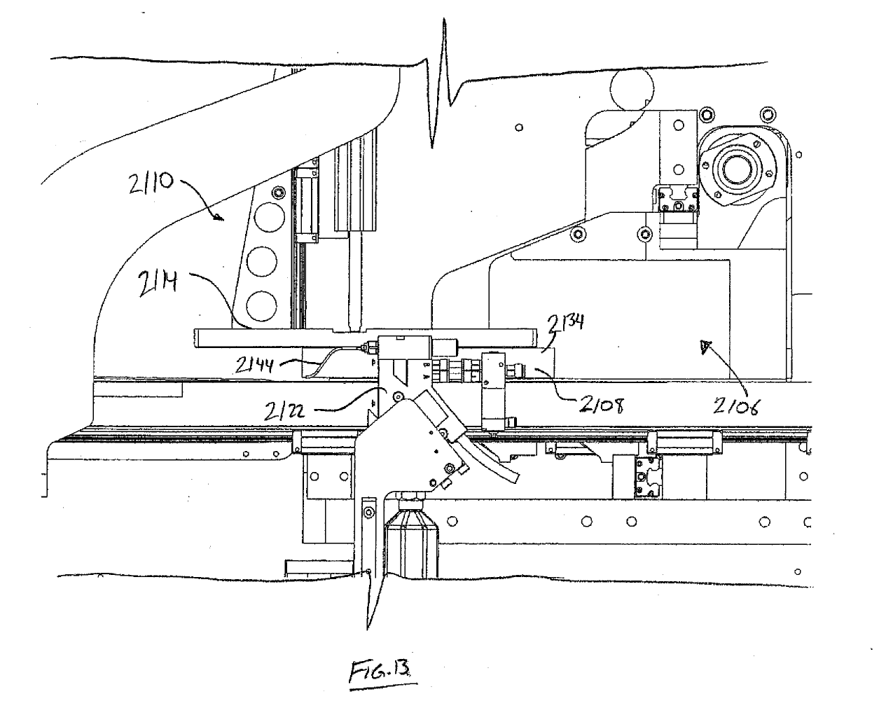

FIGS. 12 and 13 illustrate the book block 2108 moved to a second position, downstream from the first position and the glue head module 2122 is moved to a raised position, in which the glue nozzle 2128 is positioned to apply adhesive to the top sheet, or sheets, in the book block 2108.

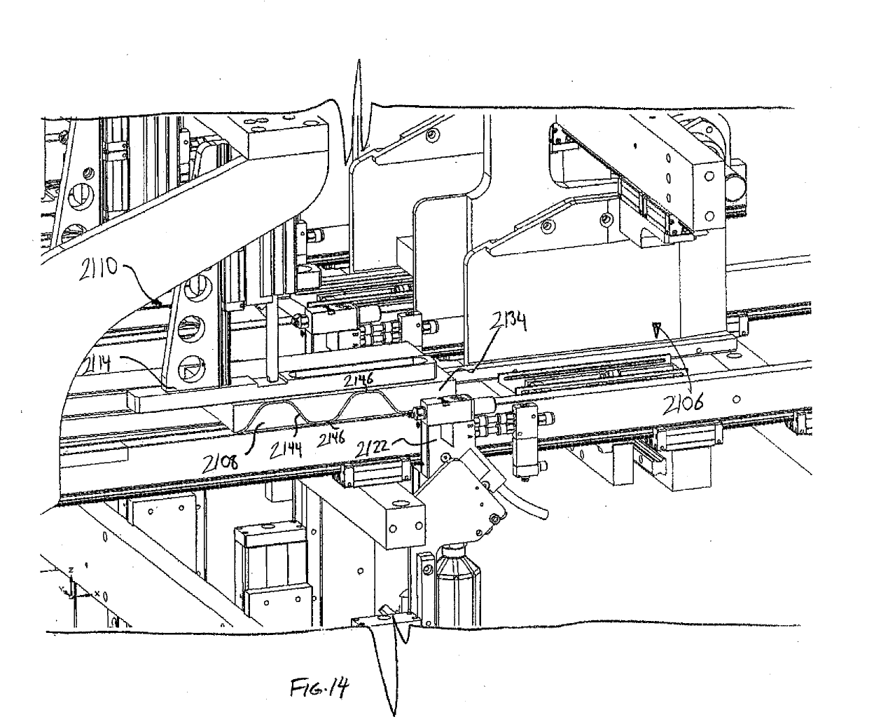

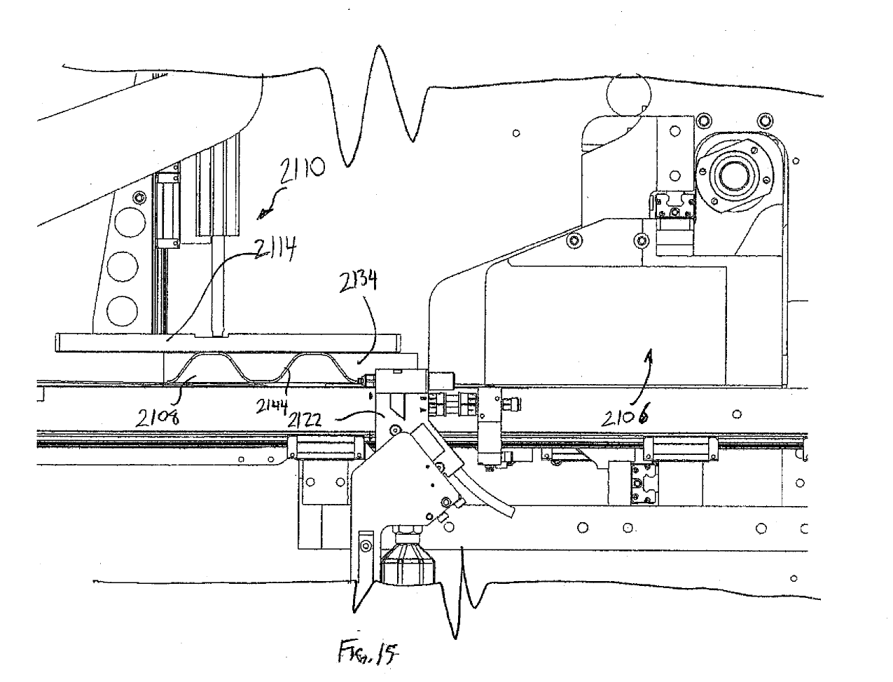

In FIGS. 14 and 15, the book block 2108 is moved to a third downstream position and the glue head module 2122 has returned to its lowered position.

The resulting combination of horizontal and vertical movement, of the book block 2108 and the glue head module 2122 respectively, can produce a bead of adhesive 2144 that traces a path across the edge 2134 of the book block 2108. In some examples the path may resemble a sine curve, and in other examples, as illustrated, the relative speeds of the book block 2108 and the glue head module 2122 can be adjusted so that the adhesive bead 2144 traces a modified sine curve pattern having extended pauses at the peaks 2146 to apply extra adhesive to the top and bottom pages in the book block, as shown in FIG. 14.

Optionally, the bead of adhesive 2144 can be applied in generally the same pattern, or path, on each book block 2108. If the bead of adhesive 2144 is applied in generally the same pattern on multiple book blocks, when/if completed book blocks 2108 are stacked on top of each other for temporary storage or handling, it may be less likely that the bead of adhesive 2144 on one book block 2108 will come into contact with the bead of adhesive 2144 on another book block 2108. This arrangement may be desirable if the book blocks 2108 are stacked while the adhesive is still sticky (for example if the book blocks are stacked before the adhesive has adequately cured/dried), because it may reduce the likelihood of the adjacent adhesive beads 2144 becoming stuck to each other.

Optionally, the shuttle 2110, clamp 2114 and adhesive applicator actuator 2136 can all be communicably connected to the batcher unit controller 2140, which can be configured automatically control the operation of these elements in the manner described above. The batcher unit controller 2140 can be a combination of both hardware and software and can be configured as a stand-alone controller or integrated as a module in another controller.

The range of motion of the each glue head module 2122 (for example between its raised and lowered positions) is independently adjustable and can be set based on the dimensions of the book being printed, a sensed height of the book block in the hopper, or any other suitable inputs, including, for example, operator input corrections.

Once the glue 2144 is applied, the clamp 2114 can release the book block onto a book block conveyor downstream from the adhesive applicator mechanisms 2112.

Optionally, the adhesive 2144 used may be selected to have desirable resilient properties to keep the book block 2108 intact during transport while still allowing flexibility for subsequent handling and processing. The glued book block 2108 is then moved down a conveyor belt for further processing. In the present example, the adhesive 2144 applied to the book block in the batcher unit 2100 is a temporary adhesive that is not intended to remain on the final product.

In some instances, clamping the book blocks using clamping mechanisms, including for example clamp plates 638, 640 and/or clamps 2114 and 3114, can induce a flaring or separation of the portion of the book block located between the clamping mechanism and the adhesive applicator. The amount of flaring can increase with the clamp spacing distance (for example distance 639 and/or 2135). Flaring may also vary depending on the material properties of the sheets (e.g. softer, more compressible sheets may tend to flare more when stacked), with environmental conditions and other factors.

Flaring at the binding edge of a book block may make reduce the effectiveness of the adhesive bead holding binding the book block together.

Moving the clamping mechanisms closer to the binding edge of a book block, for example reducing the clamp spacing distance 639, 2135, may help reduce flaring of the sheets. However, positioning the clamping mechanisms closer to the binding edge may increase the likelihood that adhesive may inadvertently be sprayed on the clamping mechanism.

For example, while the adhesive applicators described herein are intended to project adhesive on the binding edge, minor misalignments or miscalibrafions may result in the adhesive overshooting the binding edge (i.e. missing the book block) and contacting other portions of the batcher unit. If too much adhesive is sprayed on the clamping mechanism or other elements, the batcher unit may need to be shut down for cleaning. While it is desirable that the adhesive bead engage both the cover sheet and base sheet of a book block, to help maintain the integrity of the book block, spraying adhesive right to the edge of the book block can result in adhesive getting on portions of the clamp that are adjacent the binding edge.

Moving the clamp mechanism further from the binding edge of the book block may help reduce the chance of overspray hitting the clamp surfaces, but it may increase flaring. The inventors have developed a clamp mechanism with a plurality of relief surfaces and a plurality of clamping surfaces. The inventors have discovered that providing a relief surface in an area in which adhesive overspray may be expected (for example, at the upper and lower edges of the binding face) may help reduce likelihood of the overspray contacting the clamp mechanism. Instead, the overspray may fall on the surface of the cover page (or base page) of the book block.

The inventors have also noticed that spraying glue toward the binding plane and the binding edge of the book block therein, at a constant angle can make it difficult to achieve a desired adhesive application (for example engaging both the cover sheet and base sheet in a book block with adhesive), while minimizing overspray. The inventors have determined that spraying glue in a generally downward direction can be effective when spraying adhesive toward the cover sheet and upper portion of the book block, and that spraying adhesive in a generally upward direction can be effective when spraying adhesive toward the base sheet and lower portion of the book block. An adhesive applicator that is configured to spray adhesive in more than one direction may enable the adhesive applicator to spray adhesive in both a generally upwards and a generally downward direction (as illustrated).

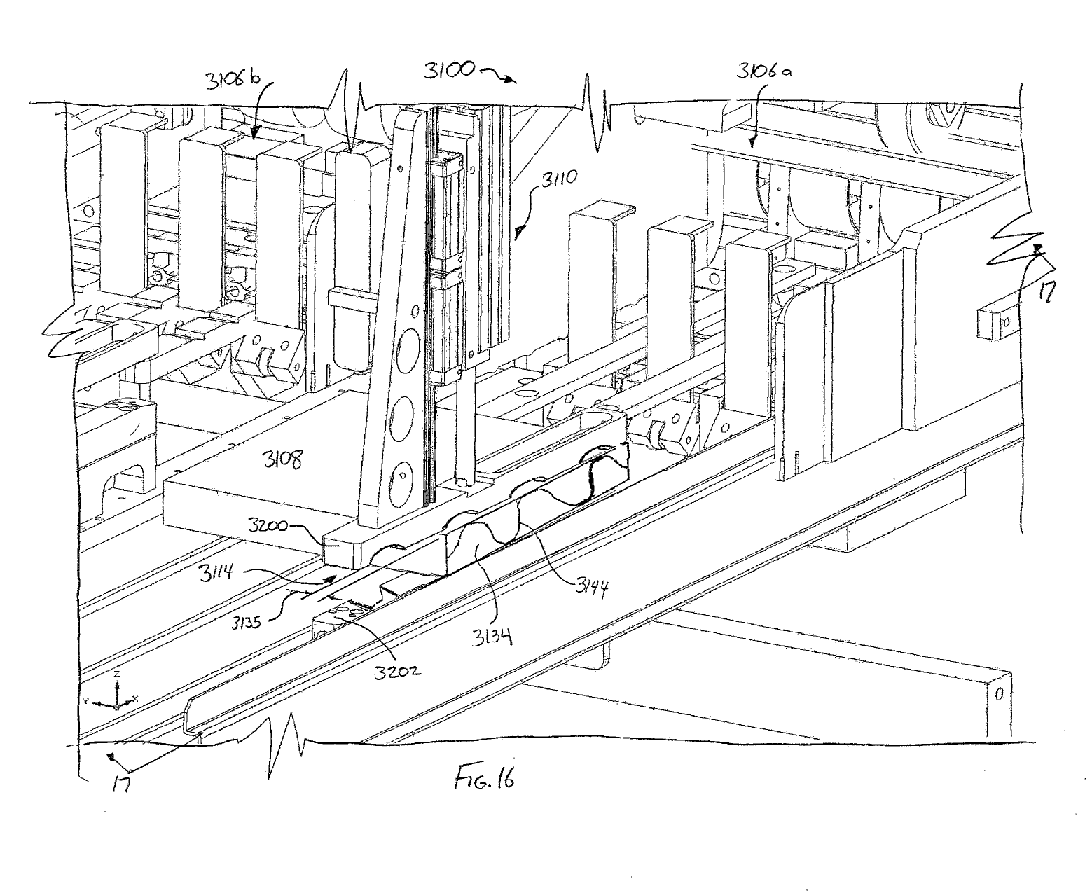

Referring to FIG. 16 a batcher unit 3100 is a multi-stream batcher unit that includes a plurality of batch hoppers within which a plurality of sheets are stacked to create book blocks, for example book block 3108 having the desired number of pages of the finished product. Batcher unit 3100 is generally similar to batcher unit 2100, and like elements are identified using like reference numerals indexed by 1000. In the illustrated example, batcher unit 3100 is also a multi-stream batcher unit but, for clarity, only portions of batcher unit 3100 are illustrated in FIGS. 16-25.

Batcher unit 3100 can include some or all of the features of the other batcher units described herein. Similarly, features described in relation to batcher unit 3100 can be used in combination with any of the other compatible features the batcher units described herein.

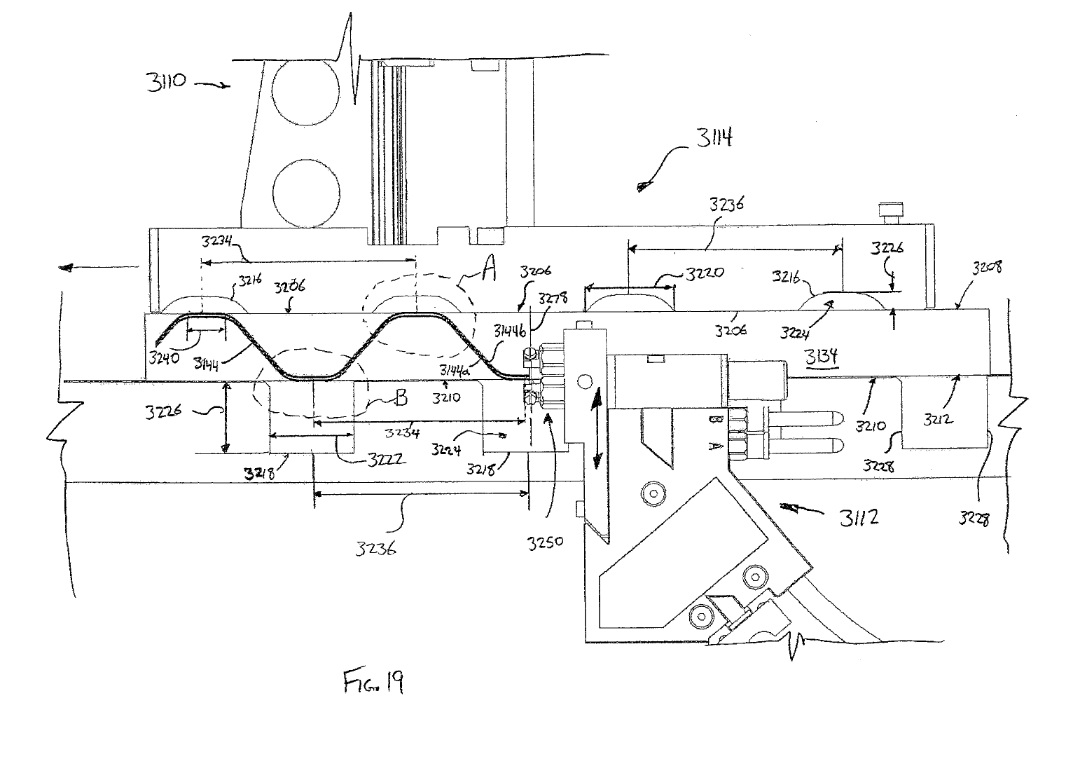

Referring to FIG. 16, batcher unit 3100 includes a shuttle apparatus 3110 and a moveable adhesive applicator mechanism 3112 (FIGS. 19 and 22-25) associated with hopper 3106. The shuttle apparatus 3110 is operable to transport completed book blocks 3108 from hoppers 3106 for further processing. In the illustrated example, each of shuttle apparatuses 3110 includes a clamp mechanism 3114 that is configured to squeeze the book blocks 3108 in a vertical direction.

Optionally, the clamp mechanism 3114 can be configured to be positionable relative close to the binding edge 3134 of the book block 3108 (i.e. to reduce the clamp spacing distance 3135) and can adapted to help prevent adhesive overspray from coating the clamp mechanism 3114.

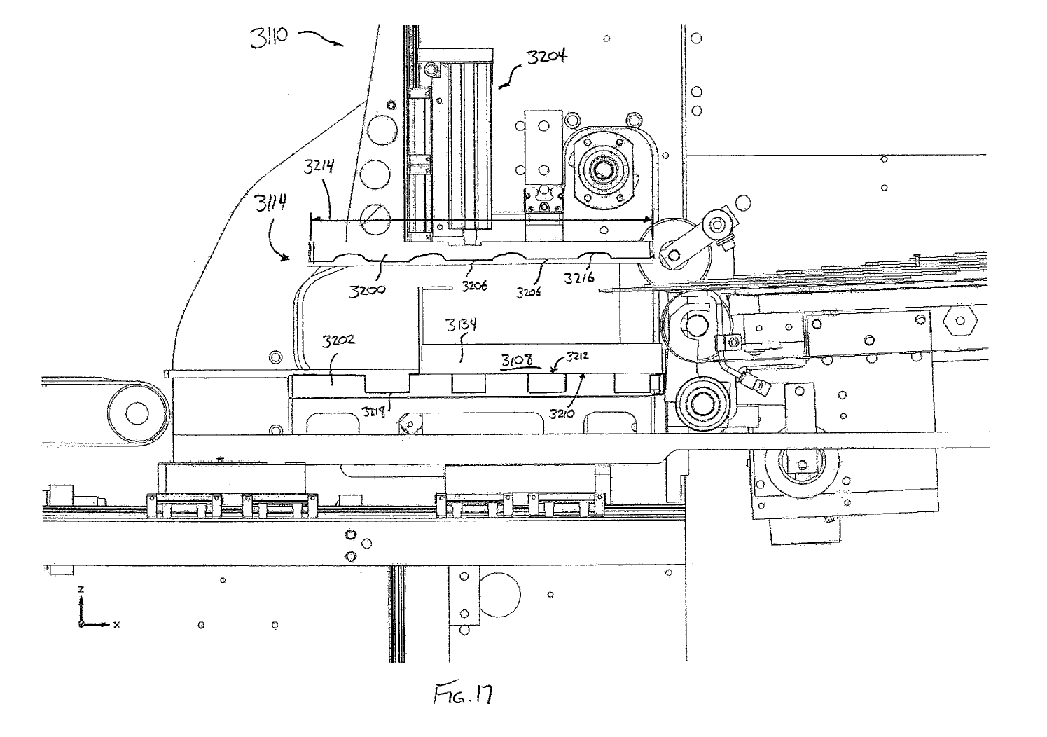

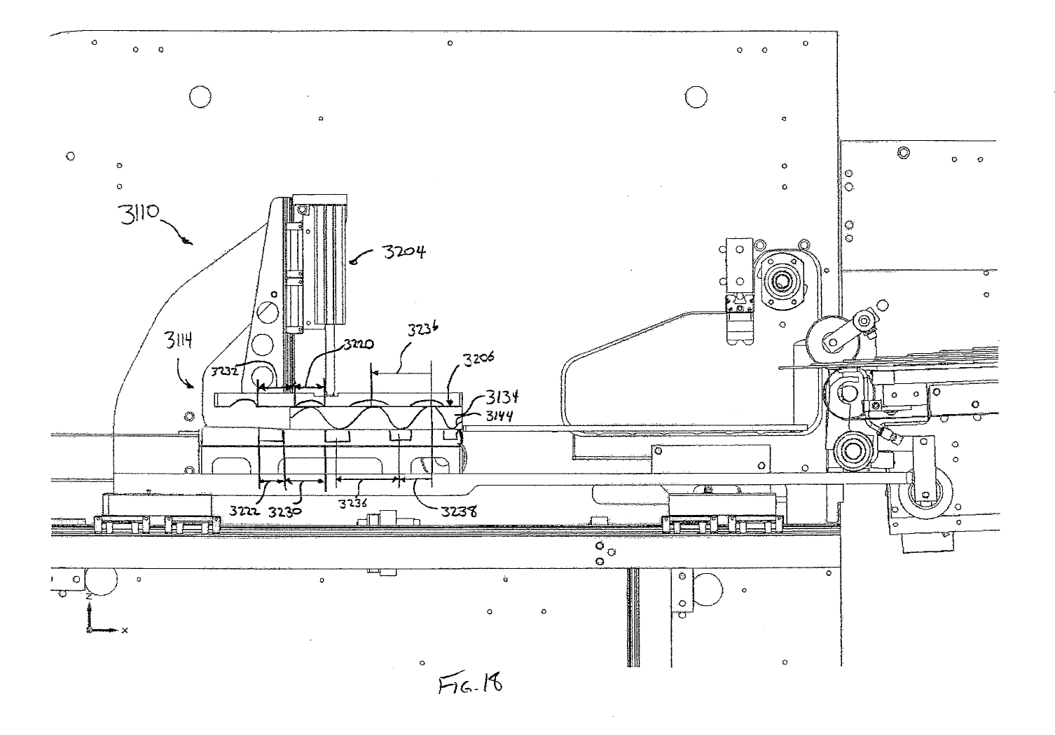

In the illustrated example, the clamp mechanism 3114 includes an upper clamp member 3200 and an opposed lower clamp member 3202. The upper clamp member 3200 is moveable towards (FIG. 18) and away (FIG. 17) from the lower clamp member 3202, using clamp actuator 3204, to selectably grip and transfer the book block (FIGS. 16, 19).

Referring to FIGS. 17 and 19, the upper clamp member 3200 can have a plurality of upper clamp surfaces 3206 to contact the outer or cover sheet 3208 of the book block 3108. The lower clamp member 3020 has a plurality of lower clamp surfaces 3210 to contact the base sheet 3212.

The upper and lower clamp surfaces 3206 and 3210 can be spaced apart from each other in the machine direction, along the length 3214 of their respective clamp members 3200 and 3202. Providing a plurality of spaced apart clamp surfaces 3206 and 3210 may help distribute the clamp force across the length of the book block 3108. Optionally, the clamp members 3200 and 3202 can have two or more clamp surfaces 3206 and 3210 separated by upper relief surfaces 3216 and lower relief surfaces 3218, respectively. Alternatively, the upper clamp member 3200 and lower clamp member 3202 can be any suitable type of clamp member.

Referring to FIGS. 18 and 19, in the illustrated example, each clamp surface 3206 and 3210 defines a respective clamp surface length 3220 and 3222. The lengths 3220 and 3222 of each clamp surface can be selected to help ensure that the clamping force is applied over a sufficient area to securely hold the book block 3108.

Optionally, the length 3220, 3222 of a clamp surface 3206, 3210 can be between about 2% and about 25% of the clamp length 3214, and can be between about 5% and about 20% of the length 3214. The sum of the clamp surface lengths for a given clamp member, a total clamp surface length (for example the sum of lengths 3220), can be between about 50% and 90% of the clamp member length 3214, and can be between about 60% and about 70% of the clamp member length 3214.

The upper clamp member 3200 can also include a plurality of upper relief surfaces 3216 to accommodate adhesive overspray. The lower clamp member 3202 can include a plurality of lower relief surfaces 3218. Each relief surface 3216, 3218 is located between adjacent ones of the respective clamp surfaces 3206 and 3210.

Gaps or recesses 3224 are formed between the upper clamp member 3200 and the cover sheet 3208. The recesses 3224 at least partially bounded by the relief surfaces 3216, which remain spaced apart from the cover sheet 3208 by respective relief clearance distances 3226 when the clamp is engaged (FIGS. 18 and 19). In the illustrated example, the upper relief surfaces 3216 in the upper clamp member 3200 are generally curved or arcuate surfaces, and the upper relief clearance distance 3226 can vary along the length 3220 of the upper relief surface 3216.

Recesses 3224 can also be formed between the lower relief surfaces 3218 and the base sheet 3212. In the illustrated example, the lower relief surfaces 3218 generally flat surfaces connected to the lower clamp surfaces 3210 by generally vertical sidewalls 3228. In this configuration, the lower relief clearance distance 3226 can remain generally constant along the length 3222 of the lower relief surface 3218.

In the illustrated example, the relief lengths 3220 and 3222 (measured as the length of the spacing between adjacent clamp surfaces, as opposed to the path length of the relief surface) are generally equal. That is, each relief surface 3216, 3218 can have the same length. Alternatively, the relief lengths 3220 and 3222 of the relief surfaces 3216 and 3218 can vary. The each relief length 3220 and 3222 can be between about 5% and about 25%, and between about 7% and about 15% of the respective clamp member length 3214. The overall relief surface length (for example a sum of the relief surface lengths 3220) can be between about 10% and about 50%, and between about 40% and 50%, of the respective clamp member length 3214. In the illustrated example the upper and lower clamp members 3200 and 3202 have the same member length 3214. Alternatively, the lengths 3214 of the upper and lower clamp members 3022 and 3202 can differ.

Referring to FIG. 18, optionally, the relief lengths can be less than the length of the opposing clamp surface. For example, the upper relief length 3220 is less than the lower clamp surface length 3230, and lower relief length 3222 is less than upper clamp surface length 3232. In this configuration, each upper relief surface 3216 opposes a lower clamp surface 3202, and there is no overlap between upper and lower relief surfaces 3216 and 3218.

Optionally, the relief surfaces 3216 and 3218 can be configured so that the maximum relief clearance distance 3226 is generally aligned with the pitch 3234 (FIG. 19) of the peaks of the adhesive beads 3144 (e.g. the location at which the adhesive applicator 3112 is spraying adhesive toward the edge of the cover sheet 3208 or base sheet 3212, explained in more detail below). Alternatively, the relief surfaces can have any other suitable configuration.

The relief surfaces 3216 and 3218 are separated from each other by respective relief spacing distances 3236, show as a centre-to-centre distances in FIG. 19. Optionally, the relief spacing distance 3236 can remain constant along the length 3214 of the upper clamp member 3200. Alternatively, distance between adjacent relief surfaces can vary. Preferably, the upper and lower relief surfaces 3216, 3218 are offset from each other by a relief offset distance 3238 (FIG. 18). Optionally, the relief offset distance 3238 can be about 50% of the pitch 3234 between adhesive bead peaks.

Optionally, the length 3240 (FIG. 19) of the peaks of the adhesive bead 3144 engaging the cover sheet 3208 can be selected to be less than the length 3220 of the upper relief surface 3216. Similarly, the length of the peaks of the adhesive engaging the base sheet 3212 can be selected to be less than the length 3222 of the relief surfaces 3218 in the lower clamp member 3202.

Referring to FIG. 19, optionally, the pitch of oscillation 3234 of the adhesive applicator 3114 can be constant. Optionally, the pitch of the oscillation 3234 of the adhesive applicator, illustrated as the peak-to-peak distances 3234, can be selected to generally match the spacing 3236 of the recesses 3224 in the upper and lower clamp members 3200 and 3202.

For example, the pitch 3234 can be between about 10 mm and about 300 mm, and optionally can be greater than 300 mm or less than 10 mm. Optionally, the pitch can be between about 25 mm and 125 mm, and in the example illustrated is about 80 mm. In this configuration, a relatively longer book block, for example a book block having a length of about 260 mm as shown in FIG. 19, could have approximately 3.25 complete cycles of adhesive applied to its binding face. A relatively shorter book block, for example a book block having a length of about 160 mm, could have approximately to 2 cycles of adhesive applied to its binding face.

In the example illustrated, selecting a constant pitch 3234 that generally matches the upper and lower relief surface spacings 3236 enables the vertical oscillation of the adhesive applicator 3112 to be registered or coordinated with the translation of the shuttle 3110 in the machine direction. In this configuration, each time the adhesive applicator 3112 is positioned to spray adhesive on edge of the cover sheet 3208 it is generally aligned with an upper relief surface 3216, and each time the adhesive applicator 3112 is positioned to spray adhesive on the edge of the base sheet 3212 it is generally aligned with a lower relief surface 3218. This may help prevent adhesive overspray from contacting the clamp surfaces 3206 and 3210.

For example, with the adhesive applicator 3112 in the position illustrated in FIG. 19, adhesive overspray at the edge of the base sheet 3212 is unlikely to contact the clamp surfaces 3210 on either side of the adhesive applicator 3112, and may not reach the relief surface 3218. Instead, the adhesive overspray may fall on the outer face of the base sheet 3212. If adhesive overspray does reach the relief surface 3218 it may be less likely to affect the clamping of subsequent book blocks, as compared to adhesive overspray deposited on a clamping surface 3210, as the relief surface 3218 does not contact the book blocks.

Providing recesses 3224 and relief surfaces 3216, 3218 that can be aligned with oscillation of the adhesive applicator 3112 may help enable reducing the clamp spacing distance 3135 (FIG. 22), while still inhibiting adhesive overspray from fouling the clamp surfaces 3206 and 3210.

Alternatively, the pitch 3234 of the oscillation can be variable, and can be adjusted based on the length of the book block. This may enable the oscillation to be selected so that a desired number of adhesive cycles can be applied to each book block. For example, the pitch may be adjusted so that each book block receives 3 cycles of adhesive (e.g. three upper peaks and three lower peaks), regardless of length.

The batcher unit 3100 can include any suitable adhesive applicator, including those described above. For example, the adhesive applicator could include a nozzle configured to apply adhesive to the binding edge of the book block in a single direction, including, for example the adhesive applicators described above. Alternatively, the batcher unit 3100 can include the adhesive applicator 3112 that is operable to apply adhesive in more than one direction.

Referring to FIGS. 19 and 22-25 an adhesive applicator 3112 includes a nozzle apparatus 3250 that is configured to spray adhesive toward the binding edge of the book block in two different directions. Alternatively, in other configurations, the nozzle apparatus can be configured to spray adhesive in more than two directions.

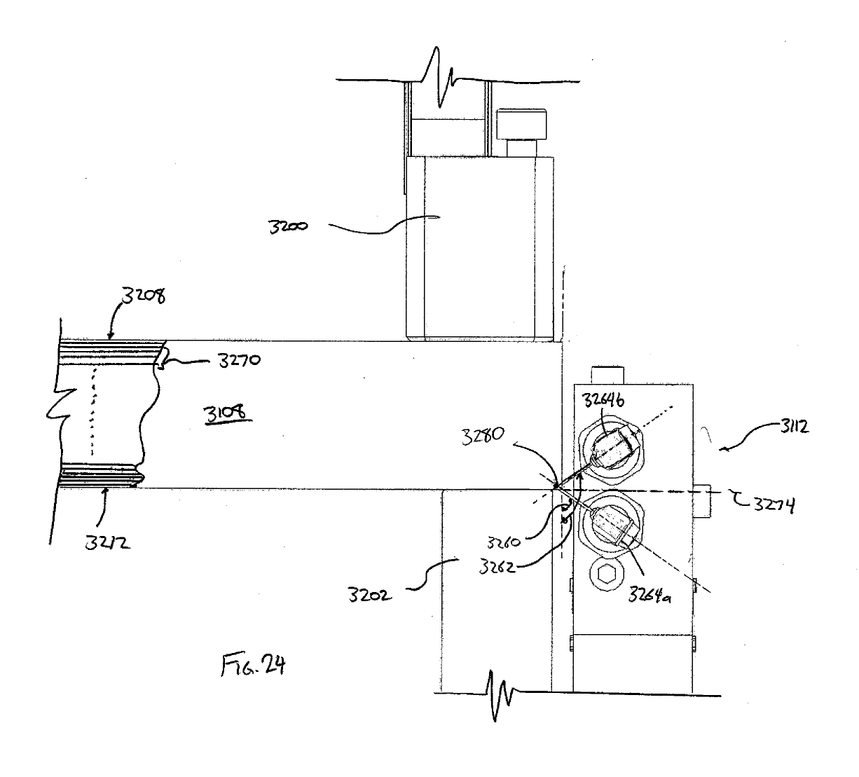

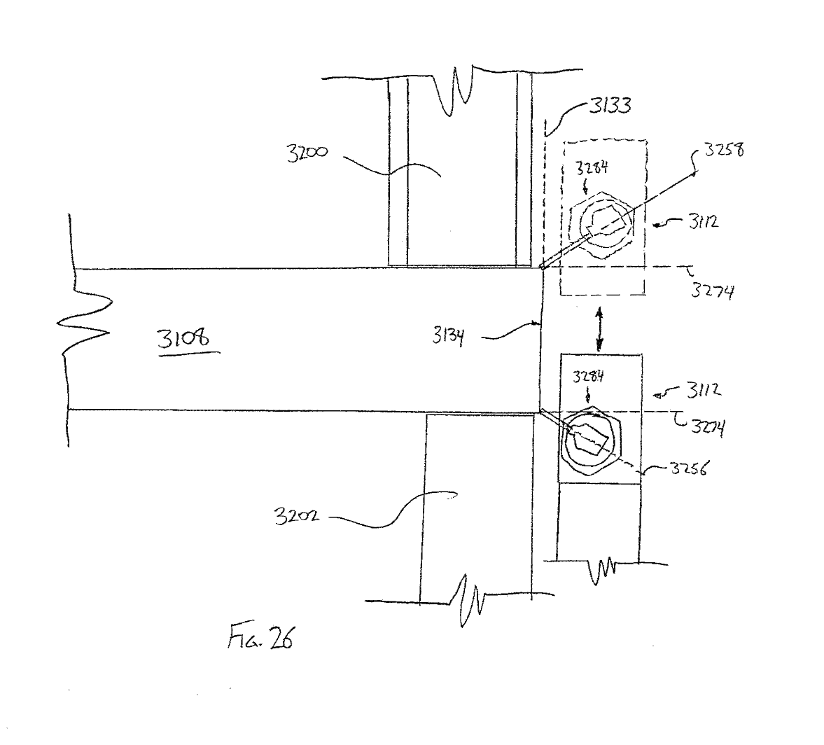

In the illustrated example, the adhesive applicator 3112 is moveable in the vertical direction (as illustrated by arrow 2252) between a lower position (FIGS. 19, 22 and 24) and an upper position (FIGS. 23 and 25). Like the adhesive applicators described above, adhesive applicator 3112 can be configured to oscillate between the upper and lower positions as the book block is shuttled downstream with the clamp, to provide a bead of adhesive 3144 on the binding edge 3134 of the book block 3108 with a desired shape.

Referring to FIG. 22, the nozzle apparatus 3250 is configured to direct a stream of adhesive 3254 toward the binding plane 3133 (containing the binding edge 3134 of the book block 3108) along a first adhesive axis 3256 when the adhesive applicator 3112 is in the lower position, and referring to FIG. 23, to direct the at least one stream of adhesive 3254 toward the binding plane 3133 along a second adhesive axis 3258 when the adhesive applicator 3112 is in the upper position. In this configuration, the first adhesive axis 3256 intersects the binding plane 3133 at a first angle 3260 and the second adhesive axis intersects 3258 the binding plane 3133 at a second angle 3262. The second angle 3262, when measure as illustrated, is greater than the first angle 3260.

In the illustrated example, the nozzle apparatus 3250 includes a lower adhesive nozzle 3264a to direct a first stream of adhesive 3254a toward the binding plane 3133 along the first adhesive axis 3256, and an upper adhesive nozzle 3264b, to direct a second stream of adhesive 3264b toward the binding plane along the second adhesive axis 3258.

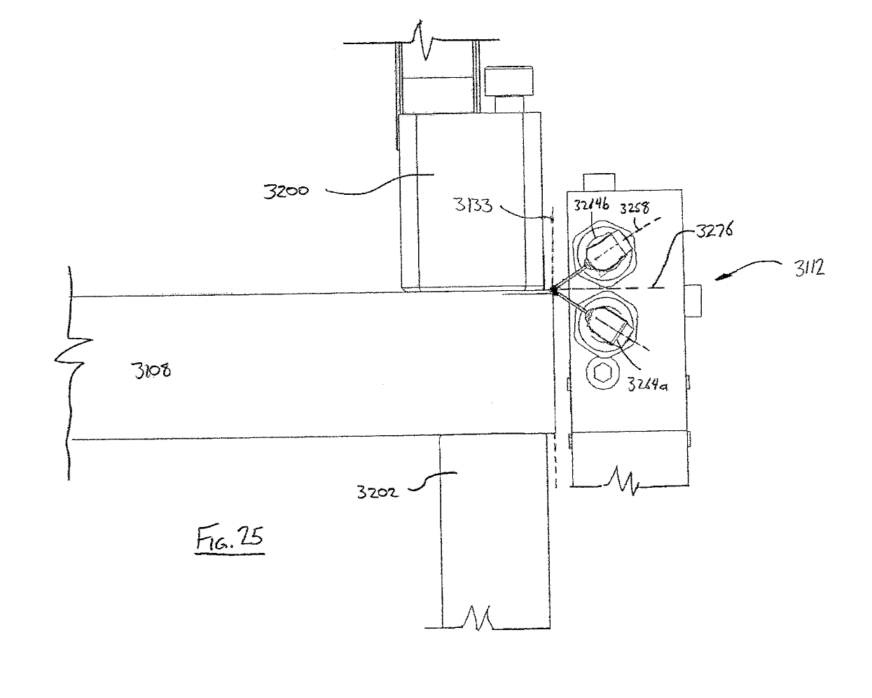

In the illustrated example, the first angle 3260 can be between about 5 degrees and about 90 degrees, between about 30 and about 60 degrees, and can be between 35 and 45 degrees. Optionally, the first angle 3260 can be greater than 90 degrees. The second angle 3262 can be between about 90 and about 175 degrees, between about 120 and 150 degrees, and between about 125 and 135 degrees. Optionally, the second angle 3262 can be less than 90 degrees. For example, as illustrated in FIG. 22, the first angle 3260 is about 30 degrees and the second angle 3262 is about 150 degrees. As illustrated in FIG. 24, the first angle 3260 is about 35 degrees, and the second angle 3262 is about 145 degrees.

Referring to FIG. 22, the upper nozzle 3264b is vertically spaced apart from the lower adhesive nozzle 3264a by a nozzle spacing distance 3266. This distance can be selected based on the type of nozzles selected, the expected height of the book blocks, space constraints in the batcher unit, and other factors. Optionally, the nozzle spacing distance 3266 can be between about 5 mm and about 150 mm, or greater than 150 mm. In some configurations, the nozzle spacing distance 3266 can be between about 25 mm and about 75 mm.

Referring to FIGS. 19-21, providing two separate adhesive nozzles 3264a,b enables the adhesive applicator 3122 to simultaneously provide two separate adhesive beads 3144a,b along the binding edge 3134 of the book block 3108, a lower adhesive bead provided 3144a by the lower nozzle 3264a, and an upper adhesive bead 3144b provided by the upper nozzle 3264b.

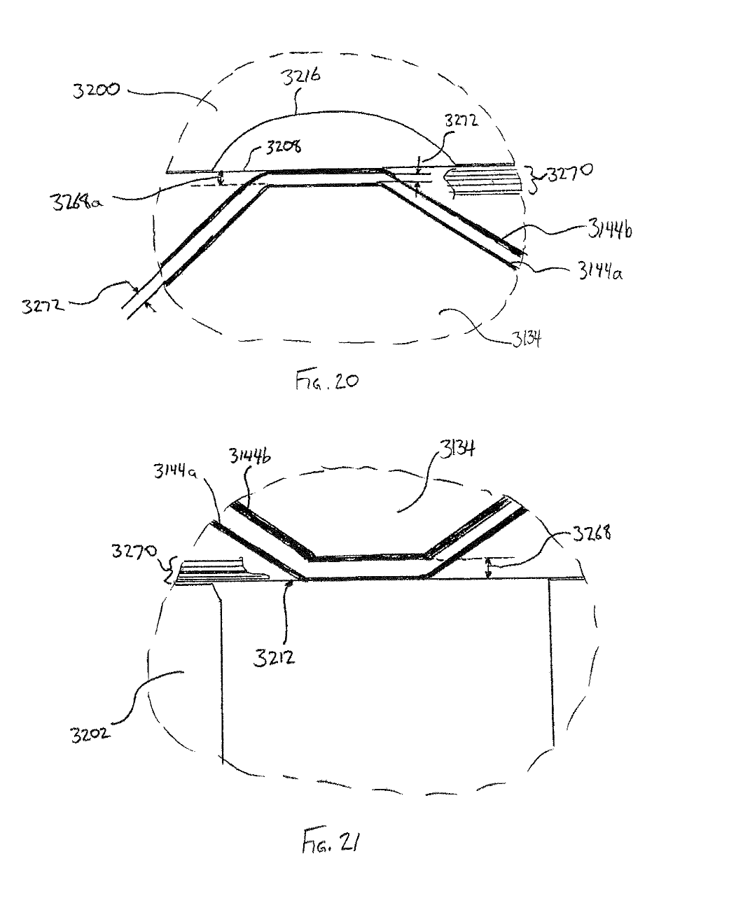

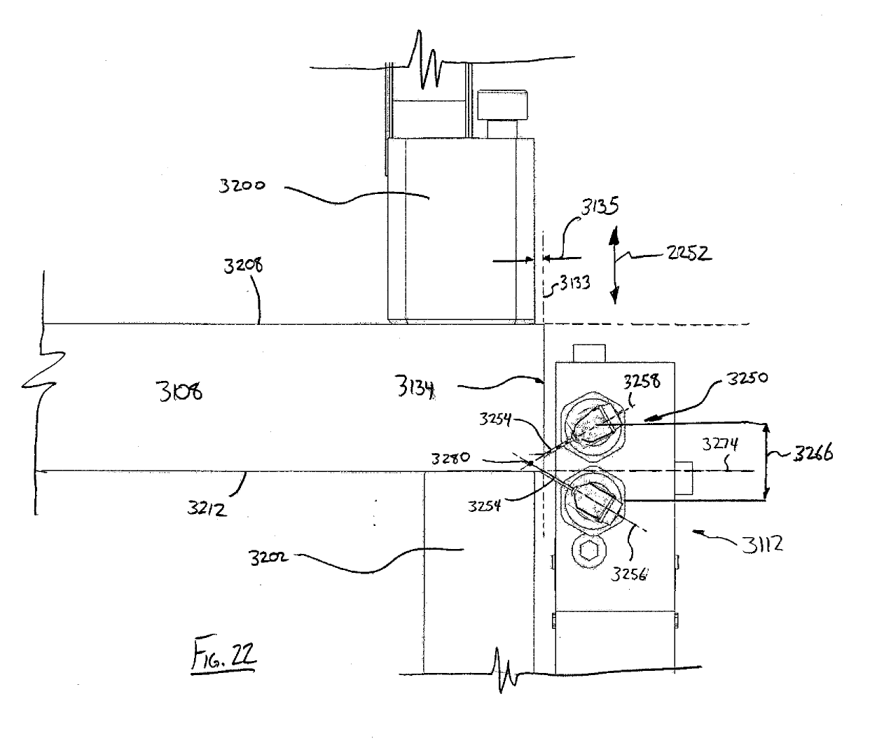

Referring also to FIGS. 20 and 21, in the illustrated example, at its highest the upper adhesive bead 3144b is configured to engage the cover sheet 3208 of the book block, but does not engage the base sheet 3212. Instead, at its lowest (FIG. 22), the upper bead 3144b remains spaced apart from the base sheet 3212 by an upper bead offset distance 3268b. Similarly, at its lowest the lower bead 3144a is configured to engage and bind the base sheet 3212, but is spaced apart from the cover sheet 3208 by a lower bead offset distance 3268a. In this configuration, neither the upper nor the lower adhesive beads 3144b,a engage both the cover sheet 3208 and the base sheet 3212. However, each adhesive bead 3144a and 3144b covers a plurality of intermediate sheets 3270 (positioned between the cover sheet and base sheet), and there are at least some sheets 3270 that are engaged or crossed by both the upper and lower adhesive beads 3144b,a. This may help maintain the integrity of the book block.

Forming the upper bead 3144b with the second nozzle 3264b enables the adhesive that engages the cover sheet 3208 to be applied in a generally downward direction, along the second adhesive axis 3258. This may help reduce unwanted overspray when forming the upper peaks of the upper adhesive bead 3144b. Forming the lower bead 3144a with the first nozzle 3264a enables the adhesive that engages the base sheet 3212 to be applied in a generally upward direction, along the first adhesive axis 3256. This may help reduce unwanted overspray when forming the lowermost peaks of the second adhesive bead 3144a.

Referring to FIG. 20, the lower adhesive bead 3144a can be offset from the upper bead 3144b by a bead spacing distance 3272. Optionally, the bead spacing distance 3272 can remain constant along the length of the upper and lower adhesive beads 3144b,a. The bead spacing distance 3272 may be adjusted by adjusting the nozzle spacing distance 3266, the first and second angles 3260, 3262 or both. The bead spacing distance 3272 can be selected based on the type of adhesive used, the height of the book block and other factors. The bead spacing distance 3272 can be between about 1 mm and about 10 mm, and can be between about 2 mm and about 5 mm. Optionally, the bead spacing distance 3272 can be greater than 10 mm.

The angles 3260, 3262 of the adhesive axes 3256, 3258 can affect the overspray adhesive from the nozzles 3264a,b. For example, positioning the first and second adhesive axes 3256 and 3258 closer to vertical (e.g. reducing first angle 3260 and/or increasing the second angle 3262) may help limit the lateral distance from the binding edge 3134 that the adhesive is applied on the horizontal surfaces of the base and cover sheet 3208, 3212, respectively. This may allow the upper and lower clamp members 3200, 3202 to be placed closer to the binding edge 3134 while still limiting the amount of adhesive sprayed on the clamp surfaces.

Optionally, the nozzle apparatus 3250 can be configured so that the position of the first and second adhesive axes 3256 and 3258 can be adjusted. For example, the first and second nozzle 3264a,b can be rotatable to adjust the direction of the first and second adhesive streams 3254a,b.

Referring to FIGS. 22, 24 and 26, in the illustrated example, when the adhesive applicator 3112 is in the first position the first adhesive axis 3256 intersects the binding plane 3133 at substantially the same elevation as a base plane 3274 containing the base sheet 3212 in the book block. Also, when the adhesive applicator 3112 is in the first position, the second adhesive axis 3258 intersects the binding plane 3133 at a higher elevation than the base plane 3274.

Referring to FIGS. 23, 25 and 26, in the illustrated example when the adhesive applicator 3112 is in the second position the second adhesive axis 3258 intersects the binding plane 3133 at substantially the same elevation as a cover plane 3276 containing a cover sheet 3208 in the book block. Also, when the adhesive applicator 3112 is in the second position, the first adhesive axis 3256 intersects the binding plane 3133 at a lower elevation than the cover plane 3274.

In the illustrated example, the first and second adhesive axes lie in a common plane 3278 (FIG. 19) and the second adhesive axis 3258 intersects the first adhesive axis 3256. Referring to FIGS. 22 and 24, the first and second adhesive axes 3256, 3258 can be configured so that the binding plane 3133 is laterally between the point of intersection 3280 of the first adhesive axis 3256 and second adhesive axis 3258 and the adhesive applicator 3122. Alternatively, the first adhesive axis 3256 and second adhesive axis 3258 can be configured so that the point of intersection lies in the binding plane 3133. In such instances, the two adhesive streams may converge and form a single adhesive bead.

Optionally, the first and second adhesive axes 3256, 3258 need not intersect each other. For example, the lower and upper nozzles 3264a,b can be directed so that the first and second adhesive axes 3256 and 3258 do not both lie in the same plane 3278, but can still direct streams of adhesive toward the binding edge 3134. Alternatively, the lower and upper nozzles 3264a,b can be spaced apart from each other in the machine direction. In this configuration the first and second adhesive axes 3256, 3258 can lie in parallel, spaced apart planes, but may not intersect.

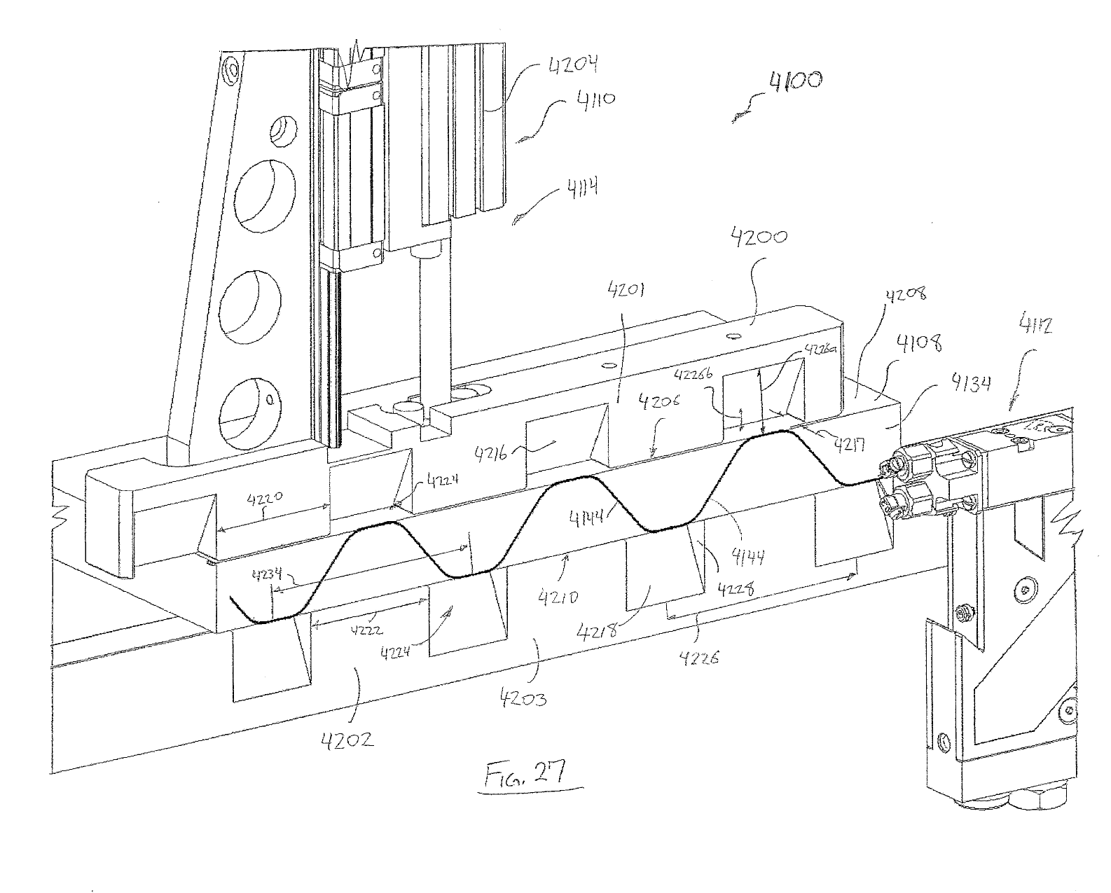

Optionally, instead of the two nozzles 3264a,b illustrated, the nozzle apparatus can include any other type of nozzle that can be configured to spray adhesive in at least two different directions. For example, referring to FIG. 26, a nozzle apparatus can include a single nozzle 3284 that is pivotally connected to the adhesive applicator 3112. In this configuration, the nozzle 3284 can be rotated to an upward facing position when the adhesive applicator 3112 is in its lower position. This may help enable the first adhesive axis 3256 to be directed generally upward, and to spray the stream of adhesive toward the base sheet 3212 in the book block. When the adhesive applicator 3112 is moved to its upper position, shown using phantom lines in FIG. 26, the nozzle 3284 can be pivoted to send the stream of adhesive generally downward from the nozzle 3284, along the second adhesive axis 3258 and toward the cover sheet 3208 of the book block. Rotation of the nozzle 3284 can be controlled by any suitable controller, or alternatively can be driven by movement of the adhesive applicator (for example using a mechanical linkage).

The batcher unit 3100 can include any suitable controller, including those described herein, that is operable to automatically control some or all of the shuttle apparatus 3110, the clamp mechanism 3114 and the adhesive applicator 3112 in the methods of operation described herein.

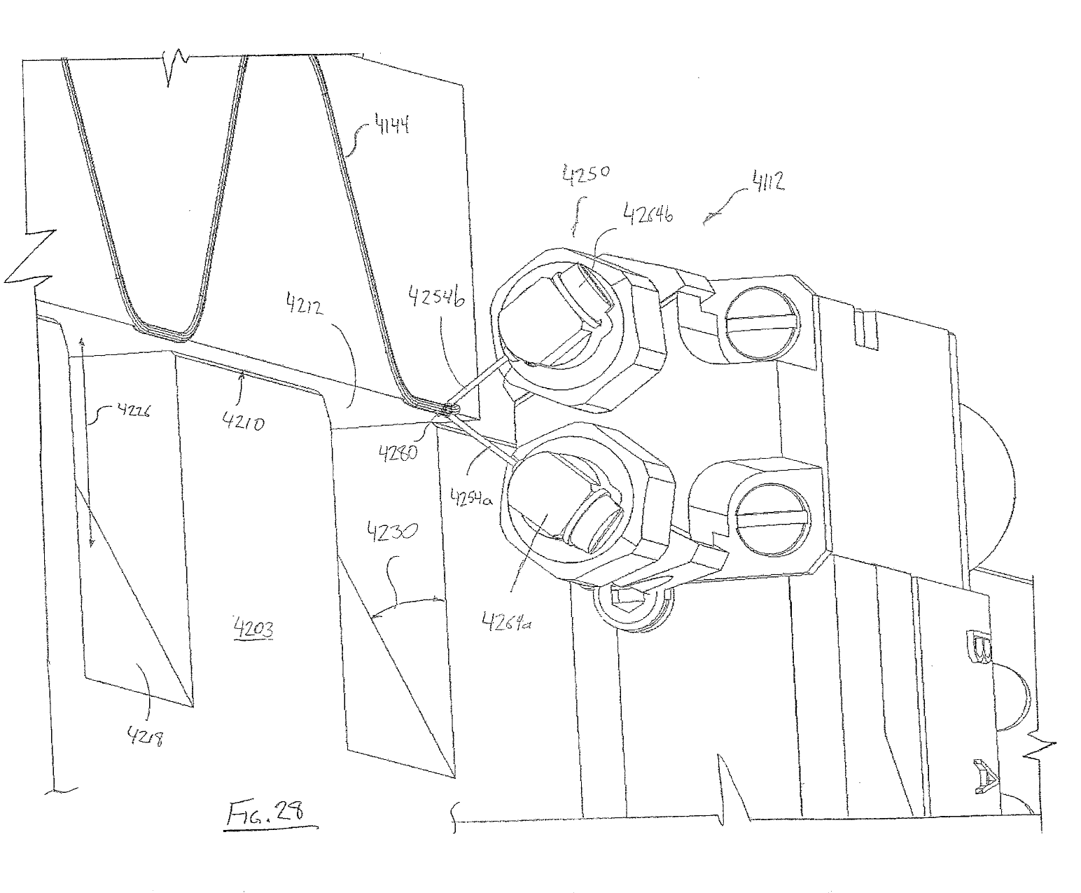

Referring to FIG. 27 another example of a batcher unit 4100 comprises an adhesive applicator 4112. Batcher unit 4100 is generally similar to batcher unit 2100, and like elements are identified using like reference numerals indexed by 2000. In the illustrated example, batcher unit 4100 can be used with a multi-stream batcher unit but, for clarity, only portions of batcher unit 4100 are illustrated in FIGS. 27-29.

Batcher unit 4100 can include some or all of the features of the other batcher units described herein. Similarly, features described in relation to batcher unit 4100 can be used in combination with any of the other compatible features the batcher units described herein.

Referring to FIG. 27, batcher unit 4100 includes a shuttle apparatus 4110 and a moveable adhesive applicator mechanism 4112. The hopper and other components of the batcher unit 4100 are not shown in FIGS. 27-29.

In the illustrated example, the shuttle 4110 includes a clamp mechanism 4114 that is configured to squeeze the book blocks 4108 in a vertical direction (as illustrated). The clamp mechanism 4114 includes an upper clamp member 4200, an opposed lower clamp member 4202, and using clamp actuator 4204, to selectably grip and transfer the book block 4108.

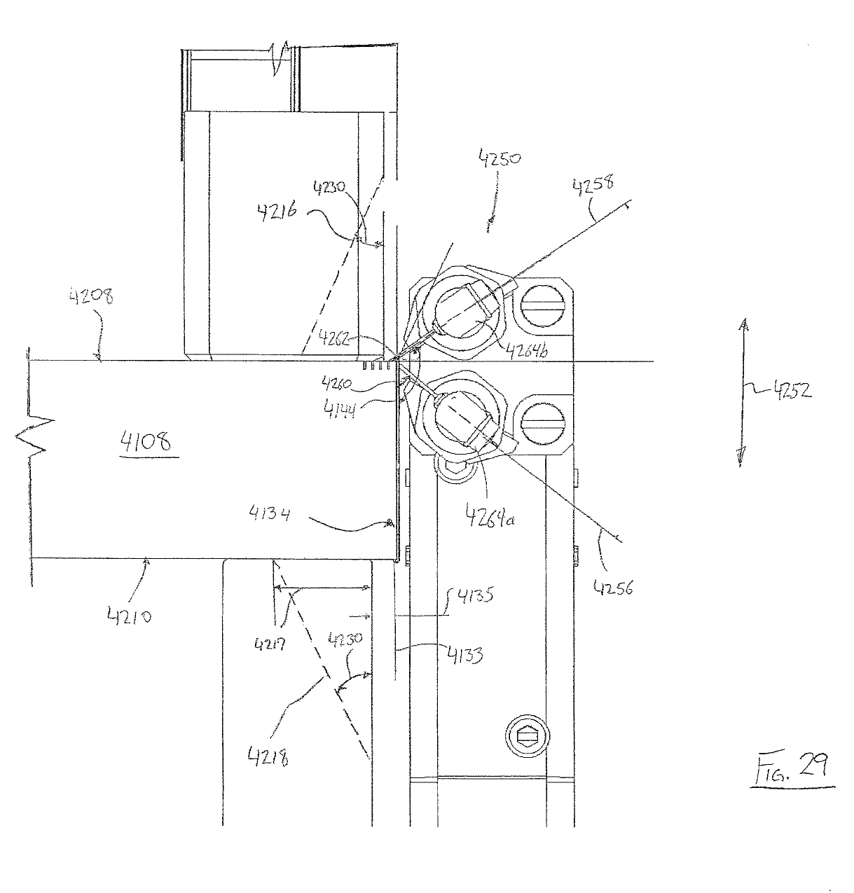

Referring to FIGS. 27 and 28, the upper clamp member 4200 can have a plurality of upper clamp surfaces 4206 to contact the outer or cover sheet 4208 of the book block 4108. The lower clamp member 4020 has a plurality of lower clamp surfaces 4210 to contact the base sheet 4212.

The upper and lower clamp surfaces 4206 and 4210 can be spaced apart from each other in the machine direction, along the length of their respective clamp members 4200 and 4202. In the illustrated example, the clamp members 4200 and 4202 can have two or more clamp surfaces 4206 and 4210 separated by upper relief surfaces 4216 and lower relief surfaces 4218, respectively.

Each clamp surface 4206 and 4210 defines a respective clamp surface length 4220 and 4222. Each relief surface 4216, 4218 is located between adjacent ones of the respective clamp surfaces 4206 and 4210. Recesses 4224 are formed between the book block 4108 and the relief surfaces 4216 and 4218.

In the illustrated example, the upper relief surfaces 4216 and the lower relief surfaces 4218 are generally identical. Each relief surface 4216, 4218 is an inclined surface connected to its adjacent clamp surfaces by generally vertical sidewalls 4228. In this configuration the sidewalls 4228 have a generally triangular shape.

The relief surfaces 4216, 4218 are configured such that the relief clearance distances 4226 vary in the lateral direction. For example, referring to FIG. 27 the relief clearance 4226a is greater than relief clearance distance 4226b. In the example illustrated, the relief surfaces 4216, 4218 are angled away from the side faces 4201 and 4203 of the upper and lower clamp members 4200, 4202, respectively.

Referring to FIG. 27, the upper relief surface 4216 intersects the cover sheet 4208 at a position that is laterally set back, by a relief set-back distance 4217, from the side face 4201 of the upper clamp member 4200. The relief set-back distance 4217 can be any suitable distance, and optionally can be between 2 mm and 50 mm. In this configuration, a plane containing the relief surface 4216 intersects both the side face 4201 and the cover sheet 4208.

Referring to FIG. 28, the angle 4230 defined between a relief surface, for example lower relief surface 4218, and its respective clamp member front face, for example front face 4203, can be selected based on a variety of factors, including, for example, to provide a desired relief set-back distance and to provide a desired relief clearance distance. Optionally, the angle 4230 can be between 5 and 85 degrees.

When the batcher unit 4100 is in use, a machine operator may monitor operation of the batcher unit 4100 and may be positioned beside the batcher unit 4100. From this position, it may be difficult for the operator to notice adhesive build-up on generally horizontal relief surfaces. Providing angled or inclined relief surfaces 4216, 4218 may help improve the visibility of the relief surfaces 4216, 4218 when the batcher unit 4100 is in use, which may help an operator see any adhesive that has accumulated on the relief surfaces 4216, 4218. If the accumulation of adhesive exceeds an acceptable level, the batcher unit 4100 can be stopped and the relief surfaces 4216, 4218 can be cleaned to remove the built-up adhesive.

The configuration of the relief surfaces 4216, 4218 may influence how much adhesive build-up can be tolerated before the machine is cleaned. In the illustrated example, the angles 4230 and set-back distances 4217 of the relief surfaces 4216, 4218 are selected so that approximately 5 mm of adhesive can build-up on the relief surfaces 4216, 4218 without substantially affecting performance of the batcher unit 4100. Providing inclined relief surfaces may also help facilitate cleaning of the relief surfaces in the event they are soiled with adhesive.

Providing recesses 4224 and relief surfaces 4216, 4218 that can be aligned with oscillation of the adhesive applicator 4112 may help enable reducing the clamp spacing distance 4135 (FIG. 29), while still inhibiting adhesive overspray from fouling the clamp surfaces 4206 and 4210.

The batcher unit 4100 can include any suitable adhesive applicator, including those described above. Referring to FIG. 29, in the illustrated example, the adhesive applicator 4112 includes a nozzle apparatus 4250 that is configured to spray adhesive toward the binding edge of the book block in two different directions.

In the illustrated example, the nozzle apparatus 4250 includes a lower adhesive nozzle 4264a to direct a first stream of adhesive 4254a toward the binding plane 4133 along the first adhesive axis 4256, and an upper adhesive nozzle 4264b, to direct a second stream of adhesive 4264b toward the binding plane along the second adhesive axis 4258.

In the illustrated example, the first angle 4260 can be between about 5 degrees and about 90 degrees, between about 30 and about 60 degrees, and can be between 35 and 45 degrees. Optionally, the first angle 4260 can be greater than 90 degrees. The second angle 3262 can be between about 90 and about 175 degrees, between about 120 and 150 degrees, and between about 125 and 135 degrees. Optionally, the second angle 4262 can be less than 90 degrees. For example, as illustrated in FIG. 29, the first angle 4260 is about 52 degrees and the second angle 4262 is about 125 degrees.

In this configuration, the nozzles 4264a,b are configured so that the adhesive streams 4254a,b converge at the binding plane 4133, and provide a single adhesive bead 4144. In the absence of a book block 4108, the converging streams 4254a,b could intersect to produce a single adhesive stream travelling generally in the horizontal direction. Optionally, the adhesive streams 4254a,b can be configured to merge at or beyond the binding plane 4133. If the streams 4254a,b converge prior to reaching the binding plane 4133, errors or misalignments of the vertical position of the nozzle apparatus 4250 relative to the book block 4108 may increase the likelihood of unwanted adhesive overspray.

The nozzles 4264a,b can be rotatable or otherwise adjustable so that the position of the point of intersection 4280 can be adjusted relative to the binding plane 4133. Optionally, the position of the point of intersection 4280 can be adjusted in the vertical direction (as illustrated) and in the lateral direction.

Alternatively, the position of the point of intersection 4280 relative to the nozzle apparatus 4250 can be fixed (for example the nozzle configuration can be fixed) and the lateral position of the adhesive applicator 4112 can be adjusted (for example closer to or farther from the binding plane 4133) to move the point of intersection 4280 relative to the binding plane 4133.

The batcher unit 4100 can include any suitable controller, including those described herein, that is operable to automatically control some or all of the shuttle apparatus 4110, the clamp mechanism 4114 and the adhesive applicator 4112 in the methods of operation described herein.

What has been described above has been intended to be illustrative of the invention and non-limiting and it will be understood by persons skilled in the art that other variants and modifications may be made without departing from the scope of the invention as defined in the claims appended hereto.

1. A batcher unit for a book block finishing machine, the batcher unit comprising:
at least one receiving member to receive a plurality of sheets and stack the plurality of sheets into a book block having a binding face lying in a binding plane;
at least one adhesive applicator to apply adhesive to the binding face of the book block to bind together the edges of plurality of sheets in the book block lying in the binding plane, the at least one adhesive applicator being moveable in a first direction relative to the binding plane between a first position and a second position;
the at least one adhesive applicator including a nozzle apparatus configured to direct at least one stream of adhesive toward the binding plane along a first adhesive axis when the adhesive applicator is in the first position, and to direct the at least one stream of adhesive toward the binding plane along a second adhesive axis when the adhesive applicator is in the second position, the first adhesive axis intersecting the binding plane at a first angle and the second adhesive axis intersecting the binding plane at a different second angle.

2. The batcher unit of claim 1, wherein the at least one adhesive applicator oscillates between the first and second positions while applying adhesive to the book block.

3. The batcher unit of claim 1, further comprising a controller communicably linked to each adhesive applicator, the controller operable to automatically control the movement of the adhesive applicator relative to the position of the book block.

4. The batcher unit of claim 1, wherein the lowermost one of the plurality of sheets forming the book block defines a base sheet and the uppermost one of the plurality of sheets forming the book block defines a cover sheet, and wherein when the adhesive applicator is in the first position the first adhesive axis intersects the binding plane at substantially the same elevation as a base plane containing the base sheet in the book block.

5. The batcher unit of claim 4, wherein when the adhesive applicator is in the second position the second adhesive axis intersects the binding plane at substantially the same elevation as a cover plane containing the cover sheet in the book block.

6. The batcher unit of claim 5, wherein the nozzle apparatus comprises a first adhesive nozzle to direct a first adhesive stream toward the binding plane along the first adhesive axis, and a second adhesive nozzle, spaced apart from the first adhesive nozzle, to direct a second adhesive stream toward the binding plane along the second adhesive axis.

7. The batcher unit of claim 6, wherein the first adhesive nozzle and the second adhesive nozzle are simultaneously operable so that the first adhesive stream and the second adhesive stream are simultaneously sprayable.

8. The batcher unit of claim 7, wherein the first adhesive nozzle and second adhesive nozzle are continuously operable while the adhesive applicator translates between the first and second positions.

9. The batcher unit of claim 8, wherein when the adhesive applicator is in the first position, the second adhesive axis intersects the binding plane at a higher elevation than the base plane.

10. The batcher unit of claim 9, wherein when the adhesive applicator is in the second position, the first adhesive axis intersects the binding plane at a lower elevation than the cover plane.

11. The batcher unit of claim 9, wherein the first adhesive nozzle is at a lower elevation than the second nozzle in the first direction.

12. The batcher unit of claim 1, wherein the second adhesive axis intersects the first adhesive axis.

13. The batcher unit of claim 1, wherein the binding plane is between the point of intersection of the first adhesive axis and second adhesive axis and the adhesive applicator.

14. The batcher unit of claim 1, further comprising a shuttle apparatus associated with the receiving member to remove the book block from the at least one receiving member, the shuttle apparatus operable to translate the book block between an upstream position and a downstream position in a second direction while the adhesive applicator moves between the first and second positions in the first direction, the second direction being different than the first direction.

15. The batcher unit of claim 1, wherein the shuttle apparatus comprises a clamp mechanism, to clamp the stacks of sheets while the adhesive is being applied, the clamp mechanism comprising a first clamp member having a first clamp surface to contact a cover sheet of the book block, and an opposed second clamp member having a second clamp surface to contact an opposed base sheet of the book block, the clamp mechanism being translatable with the shuttle in the second direction.

16. A batcher unit for a book block finishing machine, the batcher unit comprising:
at least one receiving member to receive a plurality of sheets and stack the plurality of sheets into a book block;
a shuttle apparatus associated with the receiving member and having a clamp mechanism to clamp the book block, the shuttle apparatus moveable in a machine direction to translate the clamped book block between an upstream position and a downstream position, the clamp mechanism including:
a first clamp member having at least two first clamp surfaces to contact a cover sheet of the book block, and at least one first relief surface spaced apart from the first clamp surfaces in a first direction and disposed between adjacent ones of the first clamp surfaces in the machine direction; and
an opposed second clamp member having at least one second clamp surface to contact an opposed base sheet of the book block;
whereby the first clamp member is positionable so that when an adhesive applicator is positioned to apply adhesive to an edge of the cover sheet the at least one first relief surface is aligned with the adhesive applicator to inhibit the adhesive being applied to the edge of the cover sheet from contacting the first clamp surfaces.

17. The batcher unit of claim 16, wherein the second clamp member comprises at least two second clamp surfaces and at least one second relief surface spaced apart from the second clamp surfaces in the first direction and disposed between adjacent ones of the second clamp surfaces in the machine direction, whereby the second clamp member is positionable so that when the adhesive applicator is positioned to apply adhesive to an edge of the base sheet the at least one second relief surface is generally aligned with the adhesive applicator to inhibit the adhesive being applied to the edge of the base sheet from contacting the second clamp surfaces.

18. The batcher unit of claim 17, wherein when the second relief surfaces are in contact with the base sheet the at least one second relief surface is spaced apart from the base sheet.

19. The batcher unit of claim 18, wherein when the first clamp surfaces are in contact with the cover sheet the at least one first relief surface is spaced apart from the cover sheet by a first relief clearance distance.

20. The batcher unit of claim 19, wherein the at least one first relief surface comprises at least two first relief surfaces spaced apart from each other in the machine direction by a relief spacing distance, the relief spacing distance being generally equal to a pitch of oscillation of the adhesive applicator.

21. The batcher unit of claim 20, wherein the first clamp member defines a first clamp length in the machine direction and a relief length of the at least one first relief surface is between about 5% and about 25% of the first clamp length.

22. The batcher unit of claim 21, wherein the at least one first relief surface is an arcuate surface and the first relief clearance distance varies along the length of the first relief surface.

23. The batcher unit of claim 22, wherein the at least one first relief surface is offset from the at least one second relief surface in the machine direction by a relief offset distance.

24. The batcher unit of claim 23, wherein the relief offset distance is about 50% of the first relief spacing distance.

25. The batcher unit of claim 24, wherein the at least one first relief surface opposes one second clamp surface, and the at least one second relief surface opposes one first clamp surface.

26. The batcher unit of claim 25, wherein a first relief length is less than a second clamp surface length in the machine direction.

27. The batcher unit of claim 26, wherein the at least one first relief surface comprises an inclined surface, the inclined surface comprising a first edge adjacent the cover sheet and a second edge spaced apart from the first edge, wherein the second edge is disposed between the first edge and a binding plane containing the edge of the cover sheet in the lateral direction.

28. The batcher unit of claim 27, wherein a relief plane containing the inclined surface intersects the binding plane and the cover sheet.

29. A batcher unit for a book block finishing machine, the batcher unit comprising:
at least one receiving member to receive a plurality of sheets and stack the plurality of sheets into a book block having a base sheet, an opposed cover sheet and a plurality of intermediate sheets disposed therebetween;
at least one adhesive applicator to apply adhesive to respective binding edges of the plurality of sheets to bind together the book block, the at least one adhesive applicator moveable in a first direction between a first position to apply adhesive to an edge of the cover sheet a second position to apply adhesive to an edge of the base sheet;
a shuttle apparatus associated with the receiving member and having a clamp mechanism to clamp the book block, the shuttle apparatus moveable in a machine direction to translate the clamped book block past the at least one adhesive applicator as adhesive is being applied, the clamp mechanism including:
a first clamp member having at least two first clamp surfaces to contact the cover sheet of the book block, and at least one first relief surface spaced apart from the first clamp surfaces in the first direction and disposed between adjacent ones of the first clamp surfaces in the machine direction; and
an opposed second clamp member having at least one second clamp surface to contact the opposed base sheet of the book block;
movement of the shuttle apparatus and adhesive applicator being coordinated so that when the at least one adhesive applicator is positioned to apply adhesive to the binding edge of the cover sheet the at least one first relief surface is aligned with the adhesive applicator to inhibit the adhesive being applied to the binding edge of the cover sheet from contacting the first clamp surfaces.
